(19) United States
(12) Patent Application Publication
(10) Pub. No.: US 2006/0173148 A1
(43) Pub. Date: Aug. 3, 2006

(54) Optical members, and processes, compositions and polymers for preparing them

(75) Inventors: Hiroki Sasaki, Kanagawa (JP); Ryoichi Nemori, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FrankGen Biotechnologie AG, Kronberg (DE)

(21) Appl. No.: 10/526,381

(22) PCT Filed: Sep. 4, 2003
(86) PCT No.: PCT/JP03/11301

§ 371 Date: Oct. 27, 2005

(30) Foreign Application Priority Data
Sep. 5, 2002 (JP) 2002-259862
Sep. 5, 2002 (JP) 2002-59863
Nov. 29, 2002 (JP) 20029348128

(51) Int. Cl. C08F 118/02

(52) U.S. Cl. 526/319

(57) ABSTRACT

Novel optical members formed of a polymer comprising a repeating unit derived from a polymerizable monomer (A) which is a methacrylate derivative having a branched C3-8 alkyl group or a repeating unit derived from a polymerizable monomer (3) which is a (meth)acrylate derivative having a C7-20 alicyclic hydrocarbon group are disclosed. Novel processes for preparing an optical member comprising polymerization of a composition comprising the monomer (A) or the monomer (3) are also disclosed.

### TECHNICAL FIELD

The present invention belongs to a technical field of plastic optical members, in particular belongs to a technical field of plastic optical members preferably applicable to plastic optical fibers, light guides or optical lenses, and polymerizable compositions, processes and polymers used for preparing the plastic optical members.

### RELATED ART

In recent years, plastic optical members are widely used for various applications including optical fibers and optical lenses, by virtue of its advantages such that allowing more simple preparing and processing at a lower cost as compared with quartz-base optical members having the same structure. The plastic optical fiber is slightly inferior to quartz-base fiber since the entire region of the element fiber thereof is made of plastic material and has, as a consequence, a little larger transmission loss, but superior to the quartz-base optical fiber in that having an excellent flexibility, lightweight property, workability, better applicability in preparing a large bore diameter fiber and a lower cost. The plastic optical fiber is thus studied as a transmission medium for optical communication which is effected over a distance relatively as short as allowing such large transmission loss to be ignored.

The plastic optical fiber generally has a center core (referred to as “core region” in the specification) made of an organic compound and comprises a polymer matrix, and an outer shell (referred to as “clad region” in the specification) made of an organic compound having a refractive index differing from (generally lower than) that of the core region. In particular, the plastic optical fiber having a distributed refractive index along the direction from the center to the outside thereof, namely a GI type plastic optical fiber disclosed in JPA No. 1986-130904 (the term “JPA” as used herein means an “unexamined published Japanese patent application), WO93/08488 and the like, recently attracts a good deal of attention as an optical fiber which can ensure a high transmission capacity. As one method for preparing such plastic optical fibers, it has been proposed a process comprising forming a fiber base member (referred to as “preform” in the specification) according to an interfacial gel polymerization and then drawing the preform.

As mentioned above, optical transmitters are required to have little transmission loss. In order to lower light transmission loss, it has been proposed substituting hydrogen atoms in plastic optical fibers with halogen atoms such as fluorines or deuteriums. Although (meth)acrylate-(meth)acrylate fluoride copolymers are described in JPB No. 1992-76367 (the term “JP-B” as used herein means an “examined published Japanese patent application”) which are superior to homopolymers of fluoride monomers in respect of stability and adhesiveness, they are not sufficient as a material of a plastic optical fiber. Although polymers of which hydrogen atoms binding to carbon atoms are substituted with halogen atoms are described in JPA No. 1996-220349, polymers of which the hydrogen atoms are substituted with large atoms such as Cl or Br are not desirable since their reactivities fall due to such substitutions.

On the other hand, materials for optical transmitters are required not only to have little light transmission loss, but also to be low-hydroscopic and high-thermostable. As a material for a plastic optical fiber, it has been provided cyclohexyl methacrylate-methyl methacrylate copolymers, however, in order to obtain the copolymers which are fully low-hydroscopic, it is necessary to use a large amount of cyclohexyl methacrylate and to restrict a ration of the monomers. As a result, the thermostability of the copolymer falls, and thus other copolymers improved in thermostability are required. On the other hand, it has been also provided polymers of which hydrogen atoms binding to carbon atoms are substituted with deuteriums or halogen atoms such as fluorine. However, using homopolymers of fluorinated monomers as materials for optical transmitters sometimes causes inconveniences to the optical transmitters due to their non-stability and non-adhesiveness. Thus, such homopolymers are not materials having all properties to be required as a material for an optical transmitter.

According to JPA No. 1996-220349, optical fibers formed of polymers comprising a repeating unit derived from a monomer having an alkyl group as a substituent are improved in thermostability, however, such optical fibers may not have sufficient high thermostability since the glass transition points of such polymers are not higher than that of poly methacrylate (ref. H. Kawai et al., SPIE Vol. 896 Replication and Molding of Optical Components, 69-78(1988)). Furthermore, polymers, described in JPA No. 1996-220349, of which the hydrogen atoms are substituted with large atoms such as Cl or Br are not desirable since their reactivities fall due to such substitutions.

### SUMMARY OF THE INVENTION

One object of the present invention is to provide a process and a polymerizable composition for preparing an optical member having an excellent light transmission property, especially of which light transmission loss is originally little and of which an increase of a light transmission loss caused by humidity or heat is little, in good productivity.

Another object of the present invention is to provide an optical member having an excellent light transmission property, especially of which light transmission loss is originally little and of which an increase of a light transmission loss caused by humidity or heat is little.

Another object of the present invention is to provide a method for preparing an optical member, which has an excellent light transmission property and is improved in its various properties such as thermostability and nonhydroscopic in a balanced manner, in good productivity.

Another object of the present invention is to provide an optical member which has an excellent light transmission property and is improved in its various properties such as thermostability and nonhydroscopic in a balanced manner.

In one aspect, the present invention provides a polymerizable composition comprising a polymerizable monomer composition comprising a compound (A) denoted by Formula (1) shown bellow and a compound (B) denoted by Formula (2) shown bellow:

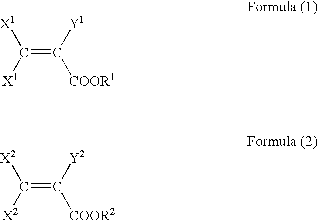

where X¹ and X² respectively denote hydrogen (H) or deuterium (D) and two X¹'s and two X²s may be identical or different each other; Y¹ and Y² respectively denote H, D, CH₃, CD₃ or fluorine (F); R¹ is a branched C3-8 alkyl group; R² is a C1-7 fluoroalkyl group substituted with 1 to 15 fluorine atoms; and the compound (A) to the compound (B) mole ratio is not less than 1/100 and less than 4/1; and

a polymerization initiator capable of initiating polymerization of the polymerizable monomer composition.

As embodiments of the present invention, the composition further comprising a chain transfer agent, and the composition further comprising a refractive index adjuster having a different refractive index from that of the polymerizable monomer composition are provided.

In another aspect, the present invention provides a process for preparing an optical member comprising polymerizing the above composition to form a region having a distributed refractive index; the process wherein the polymerization is carried out according to an interfacial-gel polymerization; an optical member prepared by the process; and an optical member essentially formed of a polymer denoted by Formula (X):

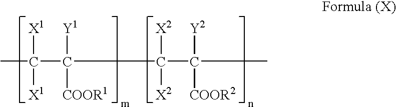

where X¹ and X² respectively denote hydrogen (H) or deuterium (D) and two X¹s and two X²s may be identical or different each other; Y¹ and Y² respectively denote H, D, CH₃, CD₃ or fluorine (F); R¹ is a branched C3-8 alkyl group; R² is a C1-7 fluoroalkyl group substituted with 1 to 15 fluorine atoms; m and n respectively denote a mole ratio of a repeating unit provided that m/n is not less than 1/100 and less than 4/1; the optical member wherein the copolymer has a weight-average molecular weight within a range from 10,000 to 1,000,000; the optical member comprising a region comprising a matrix formed of the copolymer and a compound contained in the matrix wherein the region has a concentration distribution of the compound, thereby having the distribution in the refractive index; and an optical fiber prepared by drawing an optical member of any one of the above optical members.

In another aspect, the present invention provides a process for preparing an optical member comprising polymerizing a polymerizable composition comprising a polymerizable monomer composition comprising a compound denoted by Formula (3):

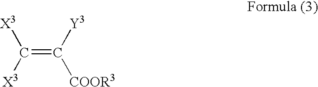

where X³ denotes hydrogen (H) or deuterium (D) and two X³s may be identical or different each other; Y³ is H, D, CH₃ or CD₃; and R³ is a C7-20 alicyclic hydrocarbon group; a polymerization initiator for initiating the polymerizable monomers composition; and a compound having a different refractive index from that of the polymerizable monomer composition, in a hollow vessel, to form a polymer toward a center from an inner surface of the vessel.

As embodiments of the present invention, the process wherein the polymerizable monomer composition further comprises a compound denoted by Formula (4):

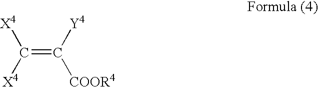

where X⁴ is H or D and two X⁴s may be identical or different each other; Y⁴ is H, D, CH₃ or CD₃; and R⁴ is a C1-7 fluoroalkyl group substituted with 1 to 15 fluorine atoms; the process wherein the polymerization of the polymerizable composition is carried out according to an interfacial-gel polymerization.

In another aspect, the present invention provides a process for preparing an optical member comprising polymerizing a polymerizable composition comprising a polymerizable monomer composition comprising a compound denoted by Formula (3):

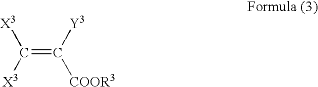

where X³ denotes hydrogen (H) or deuterium (D) and two X³s may be identical or different each other; Y³ is H, D, CH₃ or CD₃; and R³ is a C7-20 alicyclic hydrocarbon group; a polymerization initiator for initiating the polymerizable monomer composition; and a compound having a different refractive index from that of the polymerizable monomer composition, to form a region having a distributed refractive index.

As embodiments of the present invention, the process wherein the polymerizable monomer composition further comprises a compound denoted by Formula (4):

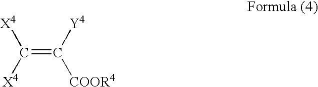

where X⁴ is H or D and two X⁴s may be identical or different each other; Y⁴ is H, D, CH₃ or CD₃; and R⁴ is a C1-7 fluoroalkyl group substituted with 1 to 15 fluorine atoms.

In another aspect, the present invention provides an optical member prepared by the process; an optical member comprising a region having a distributed refractive index which is essentially formed of a polymer having a molecular weight from 10,000 to 1000,000 and comprising a repeating unit denoted by Formula (X-1)

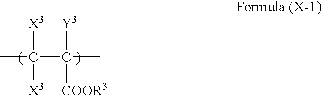

where X³ denotes hydrogen (H) or deuterium (D) and two X³s may be identical or different each other; Y³ is H, D, CH₃ or CD₃; and R³ is a C7-20 alicyclic hydrocarbon group; the optical member wherein the polymer further comprises a repeating unit denoted by Formula (X-2):

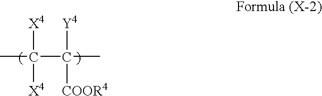

where X⁴ is H or D and two X⁴s may be identical or different each other; Y⁴ is H, D, CH₃ or CD₃; and R⁴ is a C1-7 fluoroalkyl group substituted with 1 to 15 fluorine atoms; the optical member comprising a region comprising a matrix formed of the copolymer and a compound contained in the matrix wherein the region has a concentration distribution of the compound, thereby having the distribution in the refractive index; and an optical fiber prepared by drawing an optical member of any one of the above optical members.

### BRIEF DESCRIPTION OF THE DRAWINGS

FIGS. 1 to 3 are schematic sectional views of the obtained cables in Examples.

### DETAILED DESCRIPTION OF THE INVENTION

### 1. First Embodiment of the Present Invention

The first embodiment of the present invention relates to a polymerizable composition comprising a polymerizable monomer composition comprising a polymerizable monomer (A) denoted by Formula (1) and a polymerizable monomer (B) denoted by Formula (2) in major proportion, and a polymerization initiator which can initiate polymerization of the monomer composition. The composition of the present embodiment is suitable for preparing GI type optical members. The composition may further comprise a compound, described hereinafter as an agent for adjusting refractive index, having a different refractive index from that of the monomer composition in order to create a refractive-index-distributed region.

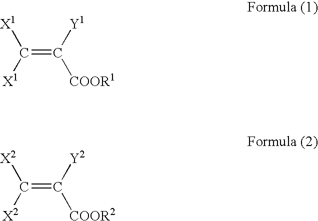

In the formulae, X¹ and X² respectively denote hydrogen (H) or deuterium (D) and two X¹s and two X²s may be identical or different each other; Y¹ and Y² respectively denote H, D, CH₃, CD₃ or fluorine (F); R¹ is a branched C3-8 alkyl group; and R² is a C1-7 fluoroalkyl group substituted with 1 to 15 fluorine atoms.

The polymerizable monomer (A) is a methacrylate derivative having a branched C3-8 alkyl group as an alkyl group, R¹, in the ester portion. The examples of R¹ include i-propyl, i-butyl, t-butyl, i-amyl, t-amyl, sec-iso-amyl, 2-octyl, 3-octyl and t-octyl. The examples of the polymerizable monomer (A) include i-propyl methacrylate, i-butyl methacrylate, t-butyl methacrylate, i-amyl methacrylate, t-amyl methacrylate, sec-iso-amyl methacrylate, 2-octyl methacrylate, 3-octyl methacrylate and t-octyl methacrylate. Among them, i-propyl methacrylate, i-butyl methacrylate, t-butyl methacrylate, i-amyl methacrylate, t-amyl methacrylate and sec-iso-amyl methacrylate are preferable, and t-butyl methacrylate and t-amyl methacrylate are more preferable.

Hydrogens of “C—H” included in a (meth)acryl group, namely at the X¹ and Y¹ positions in the Formula (1), are preferably substituted with deuteriums, and the substitution ratio from hydrogens to deuteriums is desirably not less than 95% and less than 100%. Y¹ may be deuterium or fluorine, and the preferred substitution ratio from hydrogens to deuteriums or fluorines is identical to the above, namely not less than 95% and less than 100%. Furthermore, hydrogens of “C—H” included in side chains, namely at the R¹ position in the Formula (1), may be substituted with deuteriums.

The polymerizable monomer (B) denoted by the Formula (2) is a methacrylate derivative having a C1-7 fluoroalkyl group substituted with 1 to 15 fluorine atoms as an alkyl group, R², in the ester portion. The examples of R² include monofluoromethyl, difluoromethyl, trifluoroethyl, 1H,1H-pentafluoropropyl, 1H,1H,3H-tetrafluoropropyl, 2H-hexafluoro-2-propyl, heptafluoro-2-propyl, perfluorohexylmethyl and perfluoro-t-butyl. The examples of the polymerizable monomer (B) include monofluoromethyl methacrylate, difluoroethyl methacrylate, trifluoroethyl methacrylate, 1H,1H-pentafluoropropyl methacrylate, 1H,1H,3H-tetrafluoropropyl methacrylate, 2H-hexafluoro-2-propyl methacrylate, heptafluoro-2-propyl methacrylate, perfluorohexylmethyl methacrylate and perfluoro-t-butyl methacrylate. Among them, trifluoroethyl methacrylate, 2H-hexafluoro-2-propyl methacrylate, heptafluoro-2-propyl methacrylate, perfluorohexylmethyl methacrylate and perfluoro-t-butylmethacrylate are preferable, and 2H-hexafluoro-2-propyl methacrylate, heptafluoro-2-propyl methacrylate and perfluoro-t-butyl methacrylate are more preferable.

Hydrogens of “C—H” included in a (meth)acryl group, namely at the X² and Y² positions in the Formula (2), are preferably substituted with deuteriums, and the substitution ratio from hydrogens to deuteriums is desirably not less than 95% and less than 100%. Y² may be deuterium or fluorine, and the preferred substitution ratio from hydrogens to deuteriums or fluorines is identical to the above, namely not less than 95% and less than 100%. Furthermore, hydrogens of “C—H” included in side chains, namely at the R² position in the Formula (1), may be substituted with deuteriums.

The composition may comprise a polymerizable monomer other than polymerizable monomers (A) and (B) in the combination with them unless the composition comprises the monomers (A) and (B) in major proportion. In the present specification, the term of “comprise a monomer (A) and a monomer (B) in major proportion” is used for not only the embodiments consisting of the monomers (A) and (B), but also embodiments comprising at least one polymerizable monomer other than the monomers (A) and (B) in the combination of the monomers (A) and (B) unless an optical properties of a copolymer of the monomers are not inferior to those of a polymer of the major monomers (A) and (B). The desired ratio of total amount of the polymerizable monomers (A) and (B) in all polymerizable monomers contained in the composition may range depending on various factors such as species thereof, and in general, the ratio is desirably not less than 50 wt %, more desirably not less than 60 wt % and much more desirably not less than 70 wt % with respect to total weight of all polymerizable monomers contained in the composition.

The examples of polymerizable monomers, which can be employed in the present embodiment, other than polymerizable monomers (A) and (B) include styrenes such as styrene, α-methylstyrene, chlorostyrene or bromostyrene; vinyl esters such as vinyl acetate, vinyl benzoate, vinyl phenyl acetate or vinyl chloroacetate; and maleimides such as N-n-butylmaleimide, N-tert-butylmaleimide, N-isopropylmaleimide or N-cyclohexylmaleimide; however, the examples are not limited to them. These monomers of which hydrogens are substituted with deuteriums may be also desirably used.

The monomer (A), whose content is “m” moles, to the monomer (B), whose content is “n” moles, mole ratio, namely m/n, is desirably not less than 1/100 and less than 4/1, more desirably not less than 1/50 and less than 3.5/1, and much more desirably not less than 1/25 and less than 3/1. Using a composition containing n moles of the monomer (A) and m moles of the monomer (B) wherein the n is more than 4 times of the m, may elevate a light transmission loss of an obtained optical member, especially elevate an increase in light transmission loss caused by moisture absorption remarkably. On the other hand, using a composition wherein the m is greater than 100 times of the n, may lower various properties such as product ability, mechanical property or thermostability of an obtained optical member, especially, lower thermostability when the monomer (B) has a low Tg.

The composition may comprise a polymerization initiator which can initiate copolymerization of the polymerizable monomers (A) and (B). The polymerization initiator may be selected from known initiators depending on various factors such as polymerizable monomers contained in the composition or polymerization process. The examples of the polymerization initiator include peroxides such as benzoyl peroxide (BPO), t-butylperoxy-2-ethylhexanate (PBO), di-t-butylperoxide (PBD), t-butylperoxyisopropylcarbonate (PBI) or n-butyl-4,4-bis(t-butylperoxy)valerate (PHV); and azo compounds such as 2,2′-azobisisobuthylonitrile, 2,2′-azobis(2-methylbuthylonitrile), 2,2′-azobis(2-methylpropane), 2,2′-azobis(2-methylbutane), 1,1′-azobis(cyclohexane-1-carbonitrile), 2,2′-azobis(2-methylpentane), 2,2′-azobis-(2,3-dimethylbutane), 2,2′-azobis(2-methylhexane), 2,2′-azobis(2,4-dimethylpentane), 2,2′-azobis(2,3,3-trimethylbutane), 2,2′-azobis(2,4,4-trimethylpentane), 3,3′-azobis(3-methylpentane), 3,3′-azobis(3-methylhexane), 3,3′-azobis(3,4-dimethylpentane), 3,3′-azobis(3-ethylpentane), dimethyl-2,2′-azobis(2-methylpropionate), diethyl-2,2′-azobis(methylpropionate) or di-t-butyl-2,2′-azobis(2-methylpropionate).

These polymerization initiators may be used in any combination of two or more species.

The composition may comprise a chain transfer agent. The chain transfer agent may mainly be used for adjusting molecular weight of the obtained polymer. When the composition comprising a chain transfer agent is used, a polymer having a desired molecular weight can be obtained since the polymerization rate and degree are controlled by the chain transfer agent. In the case that optical transmitters are prepared by drawing a preform formed of a polymer which is prepared by polymerization of the composition, using the composition comprising a chain transfer agent may contribute to improvement in productivity of such optical transmitters since the molecular weight of the polymer can be adjusted by the chain transfer agent so that the polymer has suitable mechanical properties for drawing. The chain transfer agent can be properly selected in consideration of the monomer to be employed. The chain transfer constants of the chain transfer agents for various monomers can be referred to publications such as “Polymer Handbook 3^{rd} edition” edited by J. BRANDRUP and E. H. IMMERGUT, published by JOHN WILEY&SON. The chain transfer constants can be obtained by experimental tests according to methods disclosed in “Kohbunshi gousei no jikkenhou (Experimental methods for polymer synthesis)” written by Takayuki Ohtsu and Masaetsu Kinoshita, published by Kagaku-Dojin Publishing Company, INC (1972).

The examples of the chain transfer agents include alkylmercaptans (n-butylmercaptan, n-pentylmercaptan, n-octylmercaptan, n-laurylmercaptan, t-dodecylmercaptan, etc.) and thiophenols (thiophenol, m-bromothiophenol, p-bromothiophenol, m-toluenethiol, p-toluenethiol, etc.). Alkylmercaptans such as n-octylmercaptan, n-laurylmercaptan, and t-dodecylmercaptan are preferable. It is also allowable to use the chain transfer agent having deuterium atoms substituting hydrogen atoms of C—H bonds. These chain transfer agents may be used in any combination of two or more species.

In the present embodiment, the polymerizable composition may comprise an agent for adjusting refractive index. A refractive-index-distributed, namely GI type, optical member can be obtained by controlling the proceeding direction of the polymerization of the composition comprising a refractive index adjuster so as to create a gradient of the agent concentration. The agent for adjusting refractive index may be a low-molecular-weight or high-molecular-weight compound. The difference between refractive indexes of a refractive index adjuster and polymerizable monomers employed in the composition is desirably not less than 0.005. The agent for adjusting refractive index is such that a refractive index of a polymer prepared by polymerization a composition containing the agent is different from (preferably higher than) that of a polymer prepared by polymerization of a composition non-containing. The agent may be a polymerizable compound and in such a case, the agent is such that a refractive index of a copolymer containing a repeating unit derived from the agent is different from (preferably higher than) that of a polymer non-containing the repeating unit. Any compounds having the foregoing properties, being stably compatible with the polymer and being stable under polymerization conditions (heating, pressurizing, etc.) for the monomer which is a source material are available.

A GI type core region can readily be obtained by controlling the proceeding direction of the polymerization of the composition comprising an agent for adjusting refractive index, typically in the interfacial gel polymerization process described later, so as to create a gradient of the agent concentration, to thereby create a distribution of refractive index based on the gradient of the agent concentration. An optical member having such a GI type core region may have exhibit a broad transmission band.

The examples of the agent for adjusting refractive index include low-molecular-weight compounds such as benzyl benzoate (BEN), diphenyl sulfide (DPS), triphenyl phosphate (TPP), benzyl-n-butyl phthalate (BBP), diphenyl phthalate (DPP), biphenyl (DP), diphenylmethane (DPM), tricresyl phosphate (TCP) or diphenyl sulfoxide (DPSO). Among them, particularly preferable species are BEN, DPS, TPP and DPSO. The examples of the agent for adjusting refractive index include polymerizable compounds such as tribromophenyl methacrylate. In the case of using a polymerizable agent, it is more difficult to adjust various properties, especially optical properties, of an obtained optical member than in the case of using a non-polymerizable agent, since a copolymerization of a polymerizable monomer and the polymerizable agent is carried out to form a matrix of the optical member, however, there is a possibility of improving thermostability of the optical member.

When heat and/or light is irradiated to the polymerizable composition, radicals and the like are generated from the initiator, thereby inducing the copolymerization of the polymerizable monomers (A), (B) and if necessary, other polymerizable monomers. If the polymerizable composition contains the agent for adjusting refractive index, the refractive-index-distributed structure can readily be obtained by controlling the proceeding direction of the polymerization, typically in the interfacial gel polymerization process described later, so as to create a concentration gradient of the agent. If the polymerizable composition doesn't contain the agent for adjusting refractive index, the refractive-index-distributed structure can be also obtained by creating a gradient in a copolymerization ratio of the polymerizable monomers. According to the present embodiment, the matrix of the obtained optical member is formed of a copolymer of polymerizable monomers (A) and (B), so that it is possible to reduce light transmission loss of the obtained optical member. Especially, it is possible to reduce the increase in light transmission loss of the optical member caused by moisture absorption remarkably. The polymer having a desired molecular weight can be obtained by adjusting a polymerization rate and/or degree with a polymerization initiator or a chain transfer agent which is optionally added to the composition. If an optical fiber is prepared by drawing a preform formed of a copolymer prepared by polymerization of the composition, the copolymer is required to have a molecular weight within a range from 10,000 to 1,000,000, preferably from 30,000 to 500,000, so as to have a suitable mechanical property for drawing. In such a case, using the composition comprising a chain transfer agent can contribute to improvement in productivity such optical fibers since the molecular weight of the polymer can be adjusted by the chain transfer agent so that the polymer has suitable mechanical properties for drawing.

An optical member containing a copolymer denoted by Formula (X) in major proportion can be prepared by polymerization of the composition.

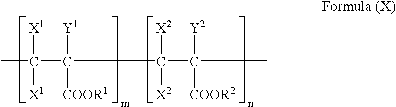

In the formulae, X¹, X², Y¹, Y², R¹ and R² are identically defined with them in the Formula (1) and (2) respectively, and the preferred scopes thereof are also identical. “m” and “n” respectively denote a mole ratio of a repeating unit provided m/n is not less than 1/100 and less than 4/1.

The molecular weight of the copolymer is desirably within a range from 10,000 to 1,000,000. If the molecular weight is lower than the 10,000, the mechanical strength of the copolymer is too low; on the other hand, if the molecular weight is higher than 1,000,000, the workability of the copolymer is too low. The copolymer having a molecular weight within the above range has properties such as thermal properties including Tg, workability in heat drawing or mechanical properties, satisfying demands for materials of optical members.

Next paragraphs will describe examples of processes for preparing GI type optical members, which have a clad region and a core region, with the polymerizable composition comprising the monomers (A) and (B), however, the processes are not limited to the examples shown below.

GI type optical members can be prepared by a process comprising a first step of preparing a hollow structure (for example a cylinder) corresponding to the clad region by carrying out polymerization of a polymerizable composition of the present embodiment; a second step of preparing a preform which comprises regions respectively corresponded to the core region and clad region by carrying out polymerization of a polymerizable composition of the present embodiment in the hollow portion of the structure; and a third step of processing the obtained preform into various forms.

The polymerizable composition used for preparing the clad region may comprise polymerizable monomers (A) and (B), a polymerization initiator capable of initiating copolymerization of the monomers and a chain transfer agent. The polymerizable composition used for preparing the core region may comprise polymerizable monomers (A) and (B), a polymerization initiator capable of initiating copolymerization of the monomers, a chain transfer agent and if necessary, a compound having a different refractive index from the monomers, namely an agent for adjusting refractive index. The kinds of the major monomers contained in the compositions, namely the monomers (A) and (B), for preparing the clad region are identical to those for preparing the core region, however, the polymerization ratios and the minor monomers thereof may not be identical. The lager amount of the monomer (B) the composition for preparing the clad region contains in comparison with the composition for preparing the core region, the larger difference in refractive index there is between the clad region and the core region.

Preferable ranges of the amount of the components respectively may properly be determined in consideration of species of the monomer to be employed, where the additional amount of the polymerization initiator is desirably within a range from 0.005 to 0.050 wt % of the polymerizable monomer composition, and more desirably within a range from 0.010 to 0.50 wt %, and the additional amount of the chain transfer agent is desirably within a range from 0.10 to 0.40 wt % of the monomer composition, and more desirably within a range from 0.15 to 0.30 wt %. In case of composition containing a refractive index adjuster, the additional amount of the agent is desirably in a range from 1 to 30 wt % of the polymerizable monomer composition, and more desirably in a range from 1 to 25 wt %.

The copolymers for the clad region and core region have desirably the molecular weight within a range from 10,000 to 1,000,000, more desirably from 30,000 to 500,000 so as to be readily drawn.

Another possible strategy relates to addition of other additives to the polymerizable composition for the clad region or the core region to an extent not degrading the light transmission property. For example, an additive can be added in order to improve the weatherability or durability. It is also allowable to add an emission inductive material for amplifying light signal for the purpose of improving the light transmission property. Since even attenuated light signal can be amplified by addition of such compound to thereby elongate the length of transmission, the compound is typically applicable to produce a fiber amplifier at a part of light transmission link.

A hollow structure (for example cylinder) made of a polymer is obtained through the first step. As typically described in International Patent Publication WO93/08488, a polymerizable composition is put into a cylindrical polymerization vessel, and then polymerization is carried out while rotating (preferably while keeping the axis of the cylinder horizontally) the vessel, referred to as “a rotational polymerization” herein after, to thereby form a cylinder made of a polymer. Before being poured into the vessel, the composition may be filtered to remove powder dusts from the composition. A suitable temperature and period for the polymerization may vary depending on species of the monomers to be employed. In general, the polymerization is preferably carried out at 60 to 90 degrees Celsius for 5 to 24 hours. The monomers used herein may be pre-polymerized before the polymerization so as to raise the viscosity thereof as described in JPA No. 1996-110419. Since the obtained hollow structure may be deformative when the vessel may get distorted by rotation, it is preferable to use a metal or glass vessel having a sufficient rigidity.

The cylinder corresponding to the clad region preferably has a bottom portion, so as that a material for the core region can be poured into the cylinder in the second step. The preferred material for the bottom portion is a material having a good affinity and adhesiveness with the polymer of the cylinder. The bottom portion may be formed of the same polymer as that of the cylinder. For example, the bottom potion can be produced by pouring a small amount of monomer into a vessel before or after carrying out the rotational polymerization; and carrying out polymerization of the monomer with still standing the vessel.

For the purpose of completely reaction of the residual monomer or the residual polymerization initiator, it is allowable after such rotational polymerization to carry out annealing at a temperature higher than the polymerization temperature, or to remove non-polymerized components.

In the first step, it is also possible to produce the structure having a desired shape (cylindrical shape in this embodiment) by molding polymer using known molding technique such as extrusion molding.

In the second step, the polymerizable composition of the present embodiment is poured into the hollow portion of the cylinder, which was obtained by the first step, corresponding to the clad region, and the polymerization of the monomers is carried out under heating. From the view point of reducing residues, the interfacial gel polymerization process, which is solvent-free, is desirable. In the interfacial gel polymerization process, the polymerization proceeds along the radial direction of the cylinder from the inner wall thereof, where viscosity is high, towards the center due to gel effect.

When the polymerizable monomer added with a refractive index adjuster is used in the polymerization, the polymerization proceeds in a way such that the monomer having a higher affinity to the polymer, of which the cylinder is made predominantly, exists in larger ratio on the inner wall of the cylinder and then polymerizes, so as to produce on the outer periphery a polymer having a lower content of the refractive index adjuster. Ratio of the refractive index adjuster in the resultant polymer increases towards the center. This successfully creates the distribution of refractive index adjuster and thus introduces the distribution of refractive index within the area corresponding to the core region.

For the case where the refractive index adjuster has a polymerizable group, the polymerizable monomers have different degrees of polymerization ability due to differential affinity to the polymer of the cylinder and differential diffusion (because of differences of intrinsic volumes and solubility parameters of the monomers) in a gel. Thus the monomer having a higher affinity to the polymer of which the cylinder is made predominantly segregates on the inner wall of the cylinder and then polymerizes, so as to produce a polymer having a higher content of such monomer. Ratio of the high-affinity monomer in the resultant polymer reduces towards the center. The distribution of refractive index can be created along the interface with the clad region to the center of the core region.

Not only the distribution of refractive index is induced into the area corresponding to the core region through the second step, but also the distribution of thermal behavior since the areas having different refractive indices are also different in the thermal behavior. If the polymerization in the second step is carried out at a constant temperature, the response property against the mass shrinkage which occurs in the polymerization reaction process may vary depending on the thermal behaviors, and thereby air bubbles or micro-gaps may generate in the obtained preform, and drawing under heating of such preform may result in that the obtained fiber has a lot of air bubbles formed therein. If the polymerization in the second step is carried out at too low temperature, the productivity may considerably lower due to low polymerization efficiency, or the light transmission performance of the resultant optical member may lower due to incomplete polymerization. On the contrary, if the polymerization in the second step is carried out at too high initial polymerization temperature, the initial polymerization rate may be so fast that the mass shrinkage of the core region cannot be reduced by a relaxation response, and as a result a lot of air bubbles may generate in the core region. Therefore, it is preferable to carry out the polymerization at a proper temperature and to carry out the after-treatment at a proper temperature respectively decided in consideration of a boiling temperature or a Tg of the used monomers. The after-treatment is desirably carried out at a temperature higher than the Tg of the polymer. For the case where isopropyl methacrylate (i-PMA) is used as the monomer (A), the polymerization is desirably carried out at a temperature within a range from 60 to 150° C., more desirably at a temperature within a range from 80 to 140° C. It is also preferable to carry out the polymerization under inert gas atmosphere applied pressure in order to improve response property against the mass shrinkage which occurs in the polymerization. Using the polymerizable monomer dehydrated and deaerated under reduces pressure may prevent an occurrence of air bubbling during the polymerization.

Preferred range of polymerization temperature and polymerization period may vary according to species of the used polymerizable monomers, however, in general, the polymerization is preferably carried out at a temperature within a range from 60 to 150° C. for a period within a range from 5 to 24 hours. For the case where i-PMA is used as a monomer (A) and 2,2′-azobis(2,4,4-trimethylpentane) is used as a polymerization initiator, first, the polymerization may be carried out at a temperature within a range from 100 to 110° C. for a period within a range from 48 to 72 hours, and secondly the polymerization may be carried out at a temperature within a range from 120 to 160° C. for a period within a range from 24 to 48 hours. The temperature elevation may be effected either in a step-wise manner or in a continuous manner, where shorter time for the elevation is preferable.

In the second step, it is preferable to carry out the polymerization under pressure (herein after referred as “pressurized polymerization”). In case of the pressurized polymerization, it is preferable to place the cylinder in the hollow space of a jig, and to carry out the polymerization while keeping the cylinder as being supported by the jig. While the pressurized polymerization is being carried out in a hollow portion of the structure corresponding to the clad region, the structure is kept as being inserted in the hollow space of the jig, and the jig prevents the shape of the structure from being deformed due to pressure. The jig is preferably shaped as having a hollow space in which the structure can be inserted, and the hollow space preferably has a profile similar to that of the structure. Since the structure corresponding to the clad region is formed in a cylindrical form in the present embodiment, it is preferable that also the jig has a cylindrical form. The jig can suppress deformation of the cylinder during the pressurized polymerization, and supports the cylinder so as to relax the shrinkage of the area corresponding to the core region with the progress of the pressurized polymerization. It is preferable that the jig has a hollow space having a diameter larger than the outer diameter of the cylinder corresponding to the clad region, and that the jig supports the cylinder corresponding to the clad region in a non-adhered manner. Since the jig has a cylindrical form in the present embodiment, the inner diameter of the jig is preferably larger by 0.1 to 40% than the outer diameter of the cylinder corresponding to the clad region, and more preferably larger by 10 to 20%.

The cylinder corresponding to the clad region can be placed in a polymerization vessel while being inserted in the hollow space of the jig. In the polymerization vessel, it is preferable that the cylinder is housed so as to vertically align the height-wise direction thereof. After the cylinder is placed, while being supported by the jig, in the polymerization vessel, the polymerization vessel is pressurized. The pressurizing of the polymerization vessel is preferably carried out using an inert gas such as nitrogen, and thus the pressurized polymerization preferably is carried out under an inert gas atmosphere. While a preferable range of the pressure during the polymerization may vary with species of the monomer, it is generally 0.05 to 1.0 MPa or around.

A preform for the plastic optical member can be obtained through the first and second steps.

In the third step, a desired optical transmission member can be obtained by processing the preform produced through above steps. For example, slicing the preform gives plate-shaped or column-shaped planar lens, and drawing under fusion gives plastic optical fiber.

A plastic optical fiber can be obtained by drawing the preform under heating. While the heating temperature during the drawing may properly be determined in consideration of source material of the preform, a generally preferable range thereof is 180 to 250° C. Conditions for the drawing (drawing temperature, etc.) may properly be determined in consideration of diameter of the obtained preform, desirable diameter of the plastic optical fiber, and source materials used. For example, the drawing tension can be set to 10 g or above in order to orient molten plastic as described in JPA No. 1995-234322, and preferably set to 100 g or below so that strain does not remain after the spinning as disclosed in JPA No. 1995-234324. The preform may be pre-heated during drawing as disclosed in JPA No. 1996-106015. As for the fiber obtained by the foregoing method, bending property and lateral pressure property thereof can be improved by specifying break elongation and hardness of the obtained element fiber as described in JPA 1995-244220.

The plastic optical fiber after being processed in the third step can directly be subjected, without any modification, to various applications. The fiber may also be subjected to various applications in a form of having on the outer surface thereof a covering layer or fibrous layer, and/or in a form having a plurality of fibers bundled for the purpose of protection or reinforcement.

For the case where a coating is provided to the element wire, the covering process is such that running the element wire through a pair of opposing dies which has a through-hole for passing the element fiber, filling a molten polymer for the coating between the opposing dies, and moving the element fiber between the dies. The covering layer is preferably not fused with the element fiber in view of preventing the inner element fiber from being stressed by bending. In the covering process, the element fiber may be thermally damaged typically through contacting with the molten polymer. It is therefore preferable to set the moving speed of the element fiber so as to minimize the thermal damage, and to select a polymer for forming the covering layer which can be melted at a low temperature range. The thickness of the covering layer can be adjusted in consideration of fusing temperature of polymer for forming the covering layer, drawing speed of the element fiber, and cooling temperature of the covering layer.

Other known methods for forming the covering layer on the fiber include a method by which a monomer coated on the optical member is polymerized, a method of winding a sheet around, and a method of passing the optical member into a hollow pipe obtained by extrusion molding.

Coverage of the element fiber enables preparing of plastic optical fiber cable. Styles of the coverage include contact coverage in which plastic optical fiber is covered with a cover material so that the boundary of the both comes into close contact over the entire circumference; and loose coverage having a gap at the boundary of the cover material and plastic optical fiber. The contact coverage is generally preferable since the loose coverage tends to allow water to enter into the gap from the end of the cover layer when a part of the cover layer is peeled off typically at the coupling region with a connector, and to diffuse along the longitudinal direction thereof. The loose coverage in which the coverage and element fiber are not brought into close contact, however, is preferably used in some purposes since the cover layer can relieve most of damages such as stress or heat applied to the cable, and can thus reduce damages given on the element fiber. The diffusion of water from the end plane is avoidable by filling the gap with a fluid gel-form, semi-solid or powdery material. The coverage with higher performance will be obtained if the semi-solid or powdery material is provided with functions other than water diffusion preventive function, such as those improving heat resistance, mechanical properties and the like.

The loose coverage can be obtained by adjusting position of a head nipple of a crosshead die, and by controlling a decompression device so as to form the gap layer. The thickness of the gap layer can be adjusted by controlling the thickness of the nipple, or compressing/decompressing the gap layer.

It is further allowable to provide another cover layer (secondary cover layer) so as to surround the existing cover layer (primary cover layer). The secondary cover layer may be added with flame retarder, UV absorber, antioxidant, radical trapping agent, lubricant and so forth, which may be included also in the primary cover layer so far as a satisfactory level of the anti-moisture-permeability is ensured.

While there are known resins or additives containing bromine or other halogen or phosphorus as the flame retarder, those containing metal hydroxide are becoming a mainstream from the viewpoint of safety such as reduction in emission of toxic gas. The metal hydroxide has crystal water in the structure thereof and this makes it impossible to completely remove the adhered water in the production process, so that the flame-retardant coverage is preferably provided as an outer cover layer (secondary cover layer) surrounding the anti-moisture-permeability layer (primary cover layer) of the present invention.

It is still also allowable to stack cover layers having a plurality of functions. For example, besides flame retardation, it is allowable to provide a barrier layer for blocking moisture absorption by the element fiber or moisture absorbent for removing water, which is typified by hygroscopic tape or hygroscopic gel, within or between the cover layers. It is still also allowable to provide a flexible material layer for releasing stress under bending, a buffer material such as foaming layer, and a reinforcing layer for raising rigidity, all of which may be selected by purposes. Besides resin, a highly-elastic fiber (so-called tensile strength fiber) and/or a wire material such as highly-rigid metal wire are preferably added as a structural material to a thermoplastic resin, which reinforces the mechanical strength of the obtained cable.

Examples of the tensile strength fiber include aramid fiber, polyester fiber and polyamide fiber. Examples of the metal wire include stainless wire, zinc alloy wire and copper wire. Both of which are by no means limited to those described in the above. Any other protective armor such as metal tube, subsidiary wire for aerial cabling, and mechanisms for improving workability during wiring can be incorporated.

Types of the cable include collective cable having element fibers concentrically bundled; so-called tape conductor having element fibers linearly aligned therein; and collective cable further bundling them by press winding or wrapping sheath; all which can be properly selected depending on applications.

The optical member of the present invention is available as an optical fiber cable for use in a system for transmitting light signal, which system comprises various light-emitting element, light-receiving element, other optical fiber, optical bus, optical star coupler, light signal processing device, optical connector for connection and so forth. Any known technologies may be applicable while making reference to “Purasuchikku Oputicaru Faiba no Kiso to Jissai (Basics and Practice of Plastic Optical Fiber)”, published by N.T.S. Co., Ltd.; optical bus typically described in JPA Nos. hei 10-123350, 2002-90571 and 2001-290055; optical branching/coupling device typically described in JPA Nos. 2001-74971, 2000-329962, 2001-74966, 2001-74968, 2001-318263 and 2001-311840; optical star coupler typically described in JPA No. 2000-241655; light signal transmission device and optical data bus system typically described in JPA Nos. 2002-62457, 2002-101044 and 2001-305395; light signal processor typically described in JPA No. 2002-23011; light signal cross-connection system typically described in JPA No. 2001-86537; optical transmission system typically described in JPA No. 2002-26815; and multi-function system typically described in JPA Nos. 2001-339554 and 2001-339555.

Outside of the above mentioned applications, the optical member of the present invention may be used in the various technical fields such as lighting systems, energy transmitters, illuminations or sensors.

### 2. Second Embodiment of the Present Invention

The second embodiment of the present invention relates to a polymerizable composition comprising a polymerizable monomer composition comprising a compound denoted by Formula (3), which may occasionally be referred to as “polymerizable monomer (3)”, a polymerization initiator and a compound having a different diffractive index from that of the monomer composition. The composition of the present embodiment is suitable for preparing GI type optical members.

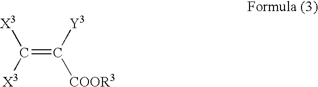

In the formula, X³ denotes hydrogen (H) or deuterium (D) and two X³s may be identical or different each other; Y³ is H, D, CH₃ or CD₃; and R³ is a C7-20 alicyclic hydrocarbon group.

The polymerizable monomer (3) is a (meth)acrylate derivative having a C7-20 alicyclic hydrocarbon group. The examples of the polymerizable monomer (3) include bicyclo-2,2,1-heptyl-2(meth)acrylate, 1-adamantyl (meth)acrylate, 2-adamantyl(meth)acrylate, 3-methyl-1-adamanthyl(meth)acrylate, 3,5-dimethyl-1-adamantyl(meth)acrylate, 3-ethyladamanthyl (meth)acrylate, 3-methyl-5-ethyl-1-adamanthyl(meth)acrylate, 3,5,8-triethyl-1-adamanthyl(meth)acrylate, 3,5-dimethyl-8-ethyl-1-adamanthyl(meth)acrylate, octahydro-4,7-menthanoindene-5-il(meth)acrylate, octahydro-4,7-menthanoidene-1-yl(meth)acrylate, 1-menthyl (meth)acrylate, tricyclodecyl(meth)acrylate, 3-hydroxy-2,6,6-trimethyl-bicycl[3,1,1]heptyl(meth)acrylate, 3,7,7-trimethyl-4-hydroxy-bicyclo[4,1,0]heptyl (meth)acrylate, (nor)bornyl(meth)acrylate, isobornyl (meth)acrylate, phentyl(meth)acrylate and 2,2,5-trimethylcyclohexyl(meth)acrylate. Among them, (nor)bornyl(meth)acrylate, isobornyl(meth)acrylate, phentyl (meth)acrylate and 1-menthyl(meth)acrylate are desirable, and (nor)bornyl(meth)acrylate, isobornyl(meth)acrylate and 1-menthyl(meth)acrylate are more desirable.

The polymerizable monomer (3) can be prepared by esterification of R³OH, where R³ is identically defined with that in the Formula (3), with alicyclic hydrocarbon-ol or by esterification of alicyclic hydrocarbon precursor with acid catalyst such as sulfuric acid or p-toluenesulfonic acid.

Hydrogens of “C—H” included in a (meth)acryl group, namely at the X³ and Y³ positions in the Formula (3), are preferably substituted with deuteriums, and the substitution ratio from hydrogens to deuteriums is desirably not less than 95% and less than 100%. Furthermore, hydrogens of “C—H” included in side chains, namely at the R³ position in the Formula (3), may be substituted with deuteriums.

From the view points of various optical properties and simplicity in processing such as plastic behavior, a preferred embodiment of the composition comprises a polymerizable monomer denoted by Formula (4), which may occasionally be referred to as “polymerizable monomer (4)”, in the combination with the polymerizable monomer (3).

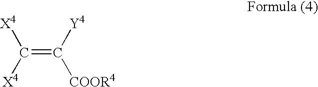

In the formula, X⁴ is H or D and two X⁴s may be identical or different each other; Y⁴ is H, D, CH₃ or CD₃; and R⁴ is a C1-7 fluoroalkyl group substituted with 1 to 15 fluorine atoms.

The polymerizable monomer (4) is a (meth)acrylate derivative having a C1-7 fluoroalkyl group substituted with 1 to 15 fluorine atoms. The examples of the polymerizable monomer (4) include monofluoromethyl methacrylate, difluoroethyl methacrylate, trifluoroethyl methacrylate, 1H,1H-pentafluoropropyl methacrylate, 1H,1H,3H-tetrafluoropropyl methacrylate, 2H-hexafluoro-2-propyl methacrylate, heptafluoro-2-propyl methacrylate, perfluorohexylmethyl methacrylate and perfluoro-t-butyl methacrylate. Among them, trifluoroethyl methacrylate, 2H-hexafluoro-2-propyl methacrylate, heptafluoro-2-propyl methacrylate, perfluorohexylmethyl methacrylate, perfluoro-t-butyl methacrylate and 1H,1H,3H-tetrafluoropropyl methacrylate are desirable, and 2H-hexafluoro-2-propyl methacrylate, 1H, 1H, 3H-tetrafluoropropyl methacrylate and perfluoro-t-butyl methacrylate are more desirable.

Hydrogens of “C—H” included in a (meth)acryl group, namely at the X⁴ and Y⁴ positions in the Formula (4), are preferably substituted with deuteriums, and the substitution ratio from hydrogens to deuteriums is desirably not less than 95% and less than 100%. Furthermore, hydrogens of “C—H” included in side chains, namely at the R⁴ position in the Formula (4), may be substituted with deuteriums.

The composition may comprise a polymerizable monomer other than a polymerizable monomer (3) in the combination with the monomer (3). The composition desirably comprises a polymerizble monomer (4) and the polymerizable monomer (3), and more desirably comprises them in major proportion. The amount of the polymerizable monomer (3) is desirably not less than 5 wt %, more desirably not less than 7.5 wt % and much more desirably not less than 10 wt % with respect to the weight of all polymerizable monomers contained in the composition. In the present specification, the term of “comprise a polymerizable monomer in major proportion” is used for not only the embodiment consisting of the monomer, but also comprising at least one polymerizable monomer other than the monomer unless an optical properties of a copolymer of the monomers are not inferior to those of a polymer of the major monomer. The desired ratio of total amount of the polymerizable monomers (3) and (4) in all polymerizable monomers contained in the composition may range depending on various factors such as species thereof, and in general, the ratio is desirably not less than 10 wt %, more desirably not less than 20 wt % and much more desirably not less than 30 wt % with respect to total weight of all polymerizable monomers contained in the composition.

The examples of polymerizable monomers, which can be employed in the present embodiment, other than polymerizable monomers (3) and (4) include (meth)acrylate esters such as methyl methacrylate, ethyl methacrylate, n-propyl methacrylate, n-butyl methacrylate, methyl acrylate, ethyl acrylate, n-propyl acrylate or n-butyl acrylate; styrenes such as styrene, α-methylstyrene, chlorostyrene or bromostyrene; vinyl esters such as vinyl acetate, vinyl benzoate, vinyl phenyl acetate or vinyl chloroacetate; and maleimides such as N-n-butylmaleimide, N-tert-butylmaleimide, N-isopropylmaleimide or N-cyclohexylmaleimide, however, the examples are not limited to them. Among them, methyl methacrylate is desirable. These monomers of which hydrogens are substituted with deuteriums may be also desirably used.

When the composition comprises polymerizable monomers (3) and (4), the monomer (3), whose content is “m” moles, to the monomer (4), whose content is “n” moles, mole ratio, namely m/n, desirably not less than 1/100 and less than 100/1, more desirably not less than 1/50 and less than 50/1, and much more desirably not less than 1/25 and less than 25/1.

The composition may comprise a polymerization initiator which can initiate polymerization of the polymerizable monomer (3) or initiate copolymerization of the polymerizable monomer (3) with another monomers such as a polymerizable monomer (4). The polymerization initiator may be selected from known initiators depending on various factors such as polymerizable monomers contained in the composition or polymerization process. The examples of the polymerization initiator include peroxides such as benzoyl peroxide (BPO), t-butylperoxy-2-ethylhexanate (PBO), di-t-butylperoxide (PBD), t-butylperoxyisopropylcarbonate (PBI) or n-butyl-4,4-bis(t-butylperoxy)valerate (PHV); and azo compounds such as 2,2′-azobisisobuthylonitrile, 2,2′-azobis(2-methylbuthylonitrile), 1,1′-azobis(cyclohexane-1-carbonitrile), 2,2′-azobis(2-methylpropane), 2,2′-azobis(2-methylbutane), 2,2′-azobis(2-methylpentane), 2,2′-azobis-(2,3-dimethylbutane), 2,2′-azobis(2-methylhexane), 2,2′-azobis(2,4-dimethylpentane), 2,2′-azobis(2,3,3-trimethylbutane), 2,2′-azobis(2,4,4-trimethylpentane), 3,3′-azobis(3-methylpentane), 3,3′-azobis(3-methylhexane), 3,3′-azobis(3,4-dimethylpentane), 3,3′-azobis(3-ethylpentane), dimethyl-2,2′-azobis(2-methylpropionate), diethyl-2,2′-azobis(methylpropionate) or di-t-butyl-2,2′-azobis(2-methylpropionate). These polymerization initiators may be used in any combination of two or more species.

The composition may comprise a chain transfer agent. The chain transfer agent may mainly be used for adjusting molecular weight of the obtained polymer. When the composition comprising a chain transfer agent is used, a polymer having a desired molecular weight can be obtained since the polymerization rate and degree are controlled by the chain transfer agent. In the case that optical transmitters are prepared by drawing a preform formed of a polymer which is prepared by polymerization of the composition, using the composition comprising a chain transfer agent may contribute to improvement in productivity of such optical transmitters since the molecular weight of the polymer can be adjusted by the chain transfer agent so that the polymer has suitable mechanical properties for drawing. The chain transfer agent can be properly selected in consideration of the monomer to be employed. The chain transfer constants of the chain transfer agents for various monomers can be referred to publications such as “Polymer Handbook 3^{rd} edition” edited by J. BRANDRUP and E. H. IMMERGUT, published by JOHN WILEY&SON. The chain transfer constants can be obtained by experimental tests according to methods disclosed in “Kohbunshi gousei no jikkenhou (Experimental methods for polymer synthesis)” written by Takayuki Ohtsu and Masaetsu Kinoshita, published by Kagaku-Dojin Publishing Company, INC (1972).

The examples of the chain transfer agents include alkylmercaptans (n-butylmercaptan, n-pentylmercaptan, n-octylmercaptan, n-laurylmercaptan, t-dodecylmercaptan, etc.) and thiophenols (thiophenol, m-bromothiophenol, p-bromothiophenol, m-toluenethiol, p-toluenethiol, etc.). Alkylmercaptans such as n-octylmercaptan, n-laurylmercaptan, and t-dodecylmercaptan are preferable. It is also allowable to use the chain transfer agent having deuterium substituting hydrogen atoms of C—H bonds. These chain transfer agents may be used in any combination of two or more species.

In the present embodiment, the polymerizable composition may comprise an agent for adjusting refractive index. A refractive-index-distributed, namely GI type, optical member can be obtained by controlling the proceeding direction of the polymerization of the composition comprising a refractive index agent so as to create a gradient of the agent concentration. The agent for adjusting refractive index may be a low-molecular-weight or high-molecular-weight compound. The difference between refractive indexes of an agent for adjusting refractive index and polymerizable monomers employed in the composition, is desirably not less than 0.005. The agent for adjusting refractive index is such that a refractive index of a polymer prepared by polymerization a composition containing the agent is different from (preferably higher than) that of a polymer prepared by polymerization of a composition non-containing. The agent may be a polymerizable compound and in such a case, the agent is such that a refractive index of a copolymer containing a repeating unit derived from the agent is different from (preferably higher than) that of a polymer non-containing the repeating unit. Any compounds having the foregoing properties, being stably compatible with the polymer and being stable under polymerization conditions (heating, pressurizing, etc.) for the monomer which is a source material are available.

A GI type core region can readily be obtained by controlling the proceeding direction of the polymerization of the composition comprising an agent for adjusting refractive index, typically in the interfacial gel polymerization process described later, so as to create a gradient of the agent concentration, to thereby create a distribution of refractive index based on the gradient of the agent concentration. An optical member having such a GI type core region may have exhibit a broad transmission band.

The examples of the agent for adjusting refractive index include low-molecular-weight compounds such as benzyl benzoate (BEN), diphenyl sulfide (DPS), triphenyl phosphate (TPP), benzyl-n-butyl phthalate (BBP), diphenyl phthalate (DPP), biphenyl (DP), diphenylmethane (DPM), tricresyl phosphate (TCP), diphenyl sulfoxide (DPSO), diphenyl sulfide derivatives or dithiane derivatives. The examples of diphenyl sulfide derivatives or dithiane derivatives are shown bellow. Among them, particularly preferable species are BEN, DPS, TPP and DPSO. These compounds of which hydrogens are substituted with deuteriums may be also desirably used in order to improve transparency of an optical transmitter in a broad wave length range.

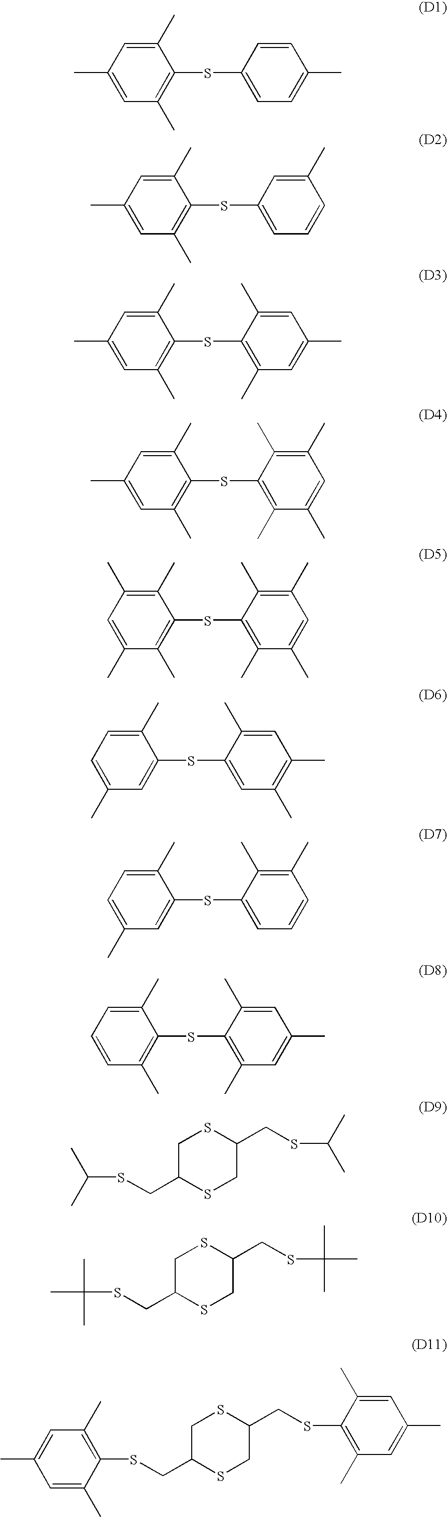

The examples of the agent for adjusting refractive index include polymerizable compounds such as tribromophenyl methacrylate. In the case of using a polymerizable agent, it is more difficult to adjust various properties, especially optical properties, of an obtained optical member than in the case of using a non-polymerizable agent, since a copolymerization of a polymerizable monomer and the polymerizable agent is carried out to form a matrix of the optical member, however, there is a possibility of improving thermostability of the optical member.

The desirable additional amount of the refractive index adjuster may be various according to how degree of increase in the refractive index the agent has or how relation between the agent and the matrix, however, in general, the desirable additional amount of the agent may be in a range of 1 to 30 wt %, more desirably in a range of 3 to 25 wt %, and furthermore desirably in a range of 5 to 20 wt %, of the polymerizable composition.

The refractive index of the obtained optical member can be varied by adjusting a concentration and/or concentration distribution of the agent. The additional amount of the agent may be decided depending on various factors such as applications of the obtained optical member or other materials. The agent may be used in any combination of two or more species.

When heat and/or light is irradiated to the polymerizable composition, radicals and the like are generated from the initiator, thereby inducing the polymerization of the polymerizable monomer (3) or the copolymerization of the polymerizable monomers (3) and (4). If the polymerizable composition contains the agent for adjusting refractive index, the refractive-index-distributed structure can readily be obtained by controlling the proceeding direction of the polymerization, typically in the interfacial gel polymerization process described later, so as to create a concentration gradient of the agent. If the polymerizable composition doesn't contain the agent for adjusting refractive index, the refractive-index-distributed structure can be also obtained by creating a gradient in a copolymerization ratio of the polymerizable monomers. According to the present embodiment, the matrix of the obtained optical member is formed of a polymer of a polymerizable monomer (3), preferbaly a copolymer of polymerizable monomers (3) and (4), so that it is possible to reduce light transmission loss of the obtained optical member. Especially, it is possible to reduce the increase in light transmission loss of the optical member caused by moisture absorption remarkably. The polymer having a desired molecular weight can be obtained by adjusting a polymerization rate and/or degree with a polymerization initiator or a chain transfer agent which is occasionally added to the composition. If an optical fiber is prepared by drawing a preform formed of a polymer prepared by polymerization of the composition, the polymer is required to have a molecular weight within a range from 10,000 to 1,000,000, preferably from 30,000 to 500,000, so as to have a suitable mechanical property for drawing. In such a case, using the composition comprising a chain transfer agent can contribute to improvement in productivity such optical fibers since the molecular weight of the polymer can be adjusted by the chain transfer agent so that the polymer has suitable mechanical properties for drawing.

One embodiment of a polymer for optical members comprises a repeating unit denoted by Formula (X-1), which is derived from a polymerizable monomer (3) and having a molecular weight within a range from 10,000 to 1,000,000; the preferred embodiment further comprises a repeating unit denoted by Formula (X-2), which is derived from a polymerizable monomer (4) and having a molecular weight within the range; and the more preferred embodiment comprises them in major proportion and having a molecular weight within the range. If the molecular weight is lower than the 10,000, the mechanical strength of the polymer is too low; on the other hand, if the molecular weight is higher than 1,000,000, the workability of the polymer is too low. The polymer having a molecular weight within the range has thermal properties including Tg, workability in heat drawing and mechanical properties respectively satisfying demands for materials of optical members

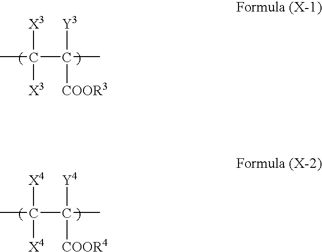

In the formulae, X³, X⁴, Y³, Y⁴, R³ and R⁴ are identically defined with them in the Formula (3) and (4) respectively, and the preferred scopes thereof are also identical.

Next paragraphs will describe examples of processes for preparing GI type optical members, which have a clad region and a core region, with the polymerizable composition containing the monomers (3) and (4), however, the processes are not limited to the examples shown below. As examples of the processes for preparing GI type optical member, a process (1) and a process (2) are described bellow.

Process (1) comprises a first step of preparing a hollow structure (for example a cylinder) corresponding to the clad region by carrying out polymerization of a polymerizable composition of the present embodiment; a second step of preparing a preform which comprises regions respectively corresponded to the core region and clad region by carrying out polymerization of a polymerizable composition of the present embodiment in the hollow portion of the structure; and a third step of processing the obtained preform into various forms.

Process (2) comprises a first step of preparing a hollow structure made of at least two concentric layers, one of which is corresponding to a clad region and another is an outer core layer, by carrying out polymerization of a polymerizable composition of the present embodiment in the hollow portion of a hollow structure (for example a cylinder) corresponding to the clad region, which is formed of a fluorine polymer such as polyvinylidene fluoride, to form the outer core layer; a second step of preparing a preform which comprises regions respectively corresponding to an inner core region, the outer core layer and clad region by carrying out polymerization of a polymerizable composition of the present embodiment in the hollow portion of the structure made of at least two concentric layers, to form the inner core region; and a third step of processing the obtained preform into various forms.

The hollow structure made of at least two concentric layers may be prepared by one step for melt co-extrusion of a fluorine polymer for the clad region and a polymer for the outer core layer.

The polymerizable composition for preparing the clad region used in the process (1) or the polymerizable composition for preparing the outer core layer used in the process (2) comprises a polymerizable monomer (3) and if necessary a polymerizable monomer (4), a polymerization initiator for initiating the monomers and a chain transfer agent. The polymerizable composition for preparing the core region used in the process (1) or the polymerizable composition for preparing the inner core region used in the process (2) comprises a polymerizable monomer (3) and if necessary a polymerizable monomer (4), a polymerization initiator for initiating the monomers, a chain transfer agent and if necessary a compound having a different refractive index from that of the monomers, namely an agent for adjusting refractive index. In the process (1), the kinds of the major monomers contained in the compositions, namely the monomer (3) or the monomers (3) and (4), for preparing the clad region are identical to those for preparing the core region; and in the process (2), the kinds of the major monomers contained in the compositions, namely the monomer (3) or the monomers (3) and (4), for preparing the outer core layer are identical to those for preparing the inner core region, however, the polymerization ratios and the minor monomers thereof may not be identical. It is possible to improve transparency and adhesiveness of the clad/core interface or outer-core/inner-core interface by using same polymerizable monomers in major proportion for preparing the clad and core regions or the outer core and inner core regions. The lager amount of the monomer (4) the composition for preparing the clad region or the outer core region contains in comparison with the composition for preparing the core region or the inner core region respectively, the larger difference in refractive index there is between the clad region and the core region or the outer core region and the inner core region.

In the process (2), the outer core layer is formed between the core and clad regions, in order to improve the adhesiveness between the clad and core region even if they are formed of absolutely different materials each other. As a results preparing the outer core layer can contribute to widening the scope of choices for materials. The hollow structure corresponding to the clad region used in the process (2) is desirably formed of a fluorine polymer which is hydrophobic and has a low refractive index, and the examples of such a fluorine polymer include polyvinylidene fluoride. The hollow structure corresponding to the clad region can be prepared by a step of carrying out melt extrusion of a commercially available fluorine polymer to form a pipe having a desired diameter and a desired thickness. The hollow structure made of at least two concentric layers can be prepared by a step of carrying out a polymerization of a polymerizable composition in the hollow of the structure corresponding to the clad region, to thereby form an outer core layer. The hollow structure made of at least two concentric layers can be also prepared by a step of carrying out a melt co-extrusion of a fluorine polymer for the clad region and a polymer for the outer core layer.

Preferable ranges of the amount of the components contained in the compositions respectively may properly be determined in consideration of species of the monomer to be employed, where the additional amount of the polymerization initiator is desirably in a range from 0.005 to 0.050 wt % of the polymerizable monomer composition, and more desirably in a range from 0.010 to 0.50 wt %, and the additional amount of the chain transfer agent is desirably in a range from 0.10 to 0.40 wt % of the monomer composition, and more desirably in a range from 0.15 to 0.30 wt %. In case of composition containing a refractive index adjuster, the additional amount of the agent is desirably in a range from 1 to 30 wt % of the polymerizable monomer composition, and more desirably in a range from 1 to 25 wt %.

The copolymers for the clad region and the core region (the term of “core region” is used hereinafter for a core region obtained by the process (1) and an inner core region obtained by the process (2)) have desirably the molecular weight within a range from 10,000 to 1,000,000, more desirably from 30,000 to 500,000 so as to be readily drawn. The molecular-weight distribution (MDW: a weight-average molecular weight/a number-average molecular weight) may affect drawing stability. If the MWD is too large, there are components having an extremely high molecular-weight, so that it is sometimes impossible to draw the preform because of the presence of such components. Accordingly, the MWD is desirably not greater than 4, and more desirably not grater than 3.

Another possible strategy relates to addition of other additives to the polymerizable composition for the clad region or the core region to an extent not degrading the light transmission property. For example, an additive can be added in order to improve the weatherability or durability. It is also allowable to add an emission inductive material for amplifying light signal for the purpose of improving the light transmission property. Since even attenuated light signal can be amplified by addition of such compound to thereby elongate the length of transmission, the compound is typically applicable to produce a fiber amplifier at a part of light transmission link.

Next, each of steps included in the process (1) and the process (2), especially the process (1), will be described in detail.

In the process (1), a hollow structure, corresponding to the clad region, for example cylinder, is obtained through the first step; and in the process (2), the hollow structure made of two concentric layers respectively corresponding to the clad region and the outer core layer is obtained through the first step. As typically described in International Patent Publication WO93/08488, a polymerizable composition is put into a cylindrical polymerization vessel or a pipe formed of a fluorine polymer, and then polymerization is carried out while rotating (preferably while keeping the axis of the cylinder horizontally) the vessel or the pipe supported by a vessel, referred to as “rotational polymerization” hereinafter, to thereby form a cylinder having one layer made of a polymer or a cylinder having two concentric layers. Before being poured into the vessel, the composition may be filtered to remove powder dusts from the composition. A suitable temperature and period for the polymerization may vary depending on species of the monomer to be employed. In general, the polymerization is preferably carried out at 60 to 150 degrees Celsius for 5 to 24 hours. The monomer used herein may be pre-polymerized before the polymerization so as to raise the viscosity thereof as described in JPA No. 1996-110419. Since the obtained hollow structure may be deformative when the vessel may get distorted by rotation, it is preferable to use a metal or glass vessel having a sufficient rigidity.

The mono-layered or double-layered hollow cylinder desirably has a bottom portion, so as that a material for the core region can be poured into the cylinder in the second step. The preferred material for the bottom portion is a material having a good affinity and adhesiveness with the polymer of the cylinder. The bottom portion may be formed of the same polymer as that of the cylinder. For example, the bottom potion can be produced by pouring a small amount of monomer into a vessel before or after carrying out rotational polymerization; and carrying out polymerization of the monomer with still standing the vessel.

For the purpose of completely reaction of the residual monomer or the residual polymerization initiator, it is allowable after such rotational polymerization to carry out annealing at a temperature higher than the polymerization temperature, or to remove non-polymerized components.

In the first step, it is also possible to produce the structure having a desired shape (cylindrical shape in this embodiment) by molding a polymer using known molding technique such as extrusion molding.

The core region is prepared through the second step, by forming a polymer toward the center from the inner surface of the mono-layered or double-layered cylinder, which was obtained through the first step. The core may be prepared by various methods such as a CVD method described in JPA No. 1996-13030, by pouring a small amount of a polymerizable into the hollow portion and polymerizing over and over as described in JPA No. 1993-173025 and JPA No. 1993-173026; or by an interfacial gel polymerization process as described in WO93/08488. From the view point of reducing residues, the interfacial gel polymerization process which is solvent-free is desirable. In the interfacial gel polymerization process, the polymerization proceeds along the radial direction of the cylinder from the inner surface thereof, where viscosity is high, towards the center due to gel effect.

When the polymerizable composition containing a refractive index adjuster is used in the polymerization, the polymerization proceeds in a way such that the monomer having a higher affinity to the polymer, of which the cylinder is made predominantly, exists in larger ratio on the inner wall of the cylinder and then polymerizes, so as to produce on the outer periphery a polymer having a lower content of the refractive index adjuster. Ratio of the refractive index adjuster in the resultant polymer increases towards the center. This successfully creates the distribution of refractive index adjuster and thus introduces the distribution of refractive index within the area corresponding to the core region.

Not only the distribution of refractive index is induced into the area corresponding to the core region through the second step, but also the distribution of thermal behavior since the areas having different refractive indices are also different in the thermal behavior. If the polymerization in the second step is carried out at a constant temperature, the response property against the mass shrinkage which occurs in the polymerization reaction process may vary depending on the thermal behaviors, and thereby air bubbles or micro-gaps may generate in the obtained preform, and drawing under heating of such preform may result in that the obtained fiber has a lot of air bubbles formed therein. If the polymerization in the second step is carried out at too low temperature, the productivity may considerably lower due to low polymerization efficiency, or the light transmission performance of the resultant optical member may lower due to incomplete polymerization. On the contrary, if the polymerization in the second step is carried out at too high initial polymerization temperature, the initial polymerization rate may be so fast that the mass shrinkage of the core region cannot be reduced by a relaxation response, and as a result a lot of air bubbles may generate in the core region. Therefore, it is preferable to carry out the polymerization at a proper temperature and to carry out the after-treatment at a proper temperature respectively decided in consideration of a boiling temperature or a Tg of the used monomers. The after-treatment is desirably carried out at a temperature higher than the Tg of the polymer. For the case where typical methacrylic esters are used as the monomer, the polymerization is desirably carried out at a temperature within a range from 60 to 160° C., more desirably at a temperature within a range from 80 to 140° C. It is also preferable to carry out the polymerization under inert gas atmosphere applied pressure in order to improve response property against the mass shrinkage which occurs in the polymerization. Using the polymerizable monomer dehydrated and deaerated under reduces pressure may prevent an occurrence of air bubbling during the polymerization. The composition may be filtered to remove powder dusts from the composition before being poured into the hollow portion.

Preferred range of polymerization temperature and polymerization period may vary according to species of the used polymerizable monomers, however, in general, the polymerization is preferably carried out at a temperature within a range from 60 to 150° C. for a period within a range from 5 to 72 hours. For the case where isobornyl methacrylate is used as a monomer (3) and 2,2′-azobis(2,4,4-trimethylpentane) is used as a polymerization initiator, first, the polymerization may be carried out at a temperature within a range from 100 to 110° C. for a period within a range from 48 to 72 hours, and secondly the polymerization may be carried out at a temperature within a range from 120 to 160° C. for a period within a range for a period within from 24 to 48 hours. For the case where di-t-butylperoxide is used as a polymerization initiator, first, the polymerization may be carried out at a temperature within a range from 90 to 110° C. for a period within a range from 4 to 48 hours, and secondly the polymerization may be carried out at a temperature within a range from 120 to 160° C. for a period within a range for a period within from 24 to 48 hours. The temperature elevation may be effected either in a step-wise manner or in a continuous manner, where shorter time for the elevation is preferable.

In the second step, it is preferable to carry out the polymerization under pressure (herein after referred as “pressurized polymerization”). In case of the pressurized polymerization, it is preferable to place the mono-layered or double-layered cylinder in the hollow space of a jig, and to carry out the polymerization while keeping the cylinder as being supported by the jig. While the pressurized polymerization is being carried out in a hollow portion of the structure corresponding to the clad region, the structure is kept as being inserted in the hollow space of the jig, and the jig prevents the shape of the structure from being deformed due to pressure. The jig is preferably shaped as having a hollow space in which the structure can be inserted, and the hollow space preferably has a profile similar to that of the structure. Since the structure corresponding to the clad region is formed in a cylindrical form in the present embodiment, it is preferable that also the jig has a cylindrical form. The jig can suppress deformation of the mono-layered or double-layered cylinder during the pressurized polymerization, and supports the cylinder so as to relax the shrinkage of the area corresponding to the core region with the progress of the pressurized polymerization. It is preferable that the jig has a hollow space having a diameter larger than the outer diameter of the mono-layered or double layered cylinder, and that the jig supports the cylinder corresponding to the clad region in a non-adhered manner. Since the jig has a cylindrical form in the present embodiment, the inner diameter of the jig is preferably larger by 0.1 to 40% than the outer diameter of the cylinder corresponding to the clad region, and more preferably larger by 10 to 20%.

The mono-layered or double-layered cylinder can be placed in a polymerization vessel while being inserted in the hollow space of the jig. In the polymerization vessel, it is preferable that the mono- or double-layered cylinder is housed so as to vertically align the height-wise direction thereof. After the cylinder is placed, while being supported by the jig, in the polymerization vessel, the polymerization vessel is pressurized. The pressurizing of the polymerization vessel is preferably carried out using an inert gas such as nitrogen, and thus the pressurized polymerization preferably is carried out under an inert gas atmosphere. While a preferable range of the pressure during the polymerization may vary with species of the monomer, it is generally 0.05 to 1.0 MPa or around.

A preform for the plastic optical member can be obtained through the first and second steps. It is to be noted now that the outer core layer may be formed of plural layers. Further it is to be noted now that the outer core layer may be united with the inner core region and not be able to be distinguished from the inner core region after being processed through the third step.

In the third step, a desired optical transmission member can be obtained by processing the preform produced through above steps. For example, slicing the preform gives plate-shaped or column-shaped planar lens, and drawing under fusion gives plastic optical fiber.

It has been described above in detail regarding to the third step and subsequent steps optionally carried out. And it has been also described above in detail regarding to the various applications of the obtained optical members.

### EXAMPLE

The present invention will specifically be described referring to the specific examples. It is to be noted that any materials, reagents, ratio of use, operations and so forth can be properly altered without departing from the spirit of the present invention. The scope of the present invention is therefore by no means limited to the specific examples shown below.

### Example 1

(Production of Clad Region)

An amount of a monomer mixture of t-butyl methacrylate (t-BMA) and 2H-hexafluoro-2-propyl methacrylate (6FM), both of them are removed a polymerization inhibitor and reduced water content sufficiently and the t-BMA to 6FM mole ratio was 1.65/1, was poured into a sufficiently-rigid cylindrical vessel having 22 mm in inner diameter and 600 mm in length, which inner diameter corresponds with the outer diameter of the preform to be obtained. And 0.5 wt % (with respect to the monomer mixture weight) of dimethyl-2,2′-azobis(2-methylpropionate) as a polymerization initiator and 0.05 wt % (with respect to the monomer mixture weight) of n-laurylmercaptan as a chain transfer agent were added to the monomer mixture. The vessel was placed in the water bath at 65° C. and the mixture was shaken and pre-polymerized at 65° C. for 2 hours. Subsequently, the mixture was allowed to polymerize under heating at 65° C. for three hours while holding the vessel horizontally and rotating it at a speed of rotation of 3,000 rpm, which was followed by annealing at 90° C. for 24 hours to thereby obtain hollow cylinder made of the copolymer of t-BMA and 6FM.

(Production of Core Region)

Next, a mixed solution of a monomer mixture of t-BMA and 6FM, both of them were removed a polymerization inhibitor and reduced water content sufficiently and the T-BMA to 6FM mole ratio was 1.65/1, and 15 wt % (with respect to the monomer mixture weight) of dibutyl phthalate as a refractive index adjuster was prepared. The mixed solution was directly poured into the hollow region of the obtained hollow cylinder while being filtered through a membrane filter, based on tetrafluoroethylene, having a pore size of 0.2 μm. 0.016 wt % (with respect to the monomer mixture weight) of dimethyl-2,2′-azobis(2-methylpropionate) as a polymerization initiator and 0.05 wt % (with respect to the monomer mixture weight) of n-laurylmercaptan as a chain transfer agent were added to the mixed solution. A cylinder thus filled with the mixed solution was housed in a glass tube having a diameter larger by 9% than the outer diameter of the cylinder, and was then allowed to stand vertically in a pressure polymerization reactor. The inner atmosphere of the pressure polymerization reactor was then purged with nitrogen, pressurized up to 0.2 MPa, and the heat polymerization was allowed to proceed at 65° C. for 48 hours and subsequently 120° C. for 24 hours with keeping the pressured atmosphere to thereby obtain the preform.

The obtained preform observed when the polymerization completed was found to have no air bubbles contained therein which possibly introduced by mass shrinkage. The preform was drawn by thermal drawing at 230° C. so as to produce a plastic optical fiber having a diameter of approx. 700 to 800 μm. The preform was not found to include air bubbles during the drawing, which contributed to successfully obtain the fiber of 300 m long in a stable manner.

Measurements revealed that the obtained fiber had a light transmission loss of as small as 160 dB/km at 650 nm wave length, and 1250 dB/km at 850 nm wave length. After allowed to stand overnight at 75° C. under RH 90%, the light transmission loss of the fiber was measured, and it was found that the increase in light transmission loss of the fiber was not larger than 60 dB/km at 850 nm.

### Examples 2 to 9 and Comparative Examples 1 to 3

Various fibers of Examples 2 to 9 and Comparative Examples 1 to 3 were produced in the same manner as Example 1, except that the species or the amounts of monomers or refractive index adjusters for the clad region or the core region were respectively changed as shown in Table 1 bellow. It was noted now that only amounts of a polymerization initiator and a chain transfer agent were changed and species thereof were not changed, such that the molecular weights of the obtained polymers were about 100,000.

TABLE 1

| | | | | | | Increase in |
|---|---|---|---|---|---|---|
| | | | | | | LTL*2 caused |
| | Clad region | Core region | | LTL*2 | | by moisture |
| | Monomers | Monomers | | 650 nm | 850 nm | absorption |
| | (mole ratio) | (mole ratio) | Dopant*1 | (dB/km) | (dB/km) | (850 nm) |
| Example 1 | t-BMA/6FM | t-BMA/6FM | DBP | 160 | 1250 | not larger than |
| | (1.65/1) | (1.65/1) | | | | 60 dB/km |
| Example 2 | i-PMA/6FM | i-PMA/6FM | DBP | 160 | 830 | not larger than |
| | (1/2) | (1/2) | | | | 60 dB/km |
| Example 3 | t-BMA/7FM | t-BMA/7FM | DBP | 165 | 1100 | not larger than |
| | (1.65/1) | (1.65/1) | | | | 60 dB/km |
| Example 4 | t-BMA/7FM | t-BMA/7FM | DBP | 170 | 830 | not larger than |
| | (1/2) | (1/2) | | | | 60 dB/km |
| Example 5 | t-BMA/7FM | t-BMA/7FM | DBP | 175 | 710 | not larger than |
| | (1/4) | (1/4) | | | | 60 dB/km |
| Example 6 | t-BMA/7FM | t-BMA/7FM | DBP | 188 | 590 | not larger than |
| | (1/10) | (1/10) | | | | 60 dB/km |
| Example 7 | t-BMA/7FM(D)/7FM | t-BMA/7FM(D)/7FM | DBP | 120 | 700 | not larger than |
| | (1/1/0.05) | (1/1/0.05) | | | | 50 dB/km |
| Example 8 | t-BMA(D)/6FM(D)/6FM | t-BMA(D)/6FM(D)/6FM | DBP | 80 | 80 | not larger than |
| | (1/1/0.02) | (1/1/0.02) | | | | 50 dB/km |
| Example 9 | t-BMA(D)/7FM(D)/7FM | t-BMA(D)/7FM(D)/7FM | DBP | 80 | 80 | not larger than |
| | (1/1/0.02) | (1/1/0.02) | | | | 50 dB/km |
| Comparative | t-BMA/6FM | t-BMA/6FM | DBP | 205 | 1800 | 150 dB/km |
| Example 1 | (5/1) | (5/1) | | | | |
| Comparative | MMA/6FM | MMA/6FM | DBP | 210 | 2700 | 800 dB/km |
| Example 2 | (10/1) | (10/1) | | | | |
| Comparative | EMA/6FM | EMA/6FM | DBP | 210 | 2500 | 500 dB/km |
| Example 3 | (10/1) | (10/1) | | | | |

*1 an agent for adjusting refractive index
*2 light transmission loss

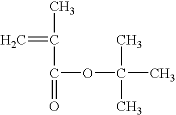

t-BMA

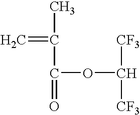

6FM

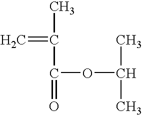

i-PMA

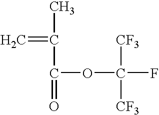

7FM

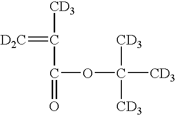

t-BMA(D)

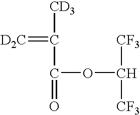

6FM(D)

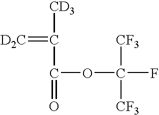

7FM(D)

### Example 11

(Production of Clad Region)

An amount of a monomer mixture of isobornyl methacrylate (IBXMA) and 2H-hexafluoro-2-propyl methacrylate (6FM), both of them are reduced water content by 1000 ppm, and the IBXMA to 6FM weight ratio was 1/1, was poured into a sufficiently-rigid cylindrical vessel having 22 mm in inner diameter and 600 mm in length, which inner diameter corresponds with the outer diameter of the preform to be obtained. And 0.5 wt % (with respect to the monomer mixture weight) of dimethyl-2,2′-azobis(2-methylpropionate) as a polymerization initiator and 0.62 wt % (with respect to the monomer mixture weight) of n-laurylmercaptan as a chain transfer agent were added to the monomer mixture. The vessel was placed in the water bath at 60° C. and the mixture was shaken and pre-polymerized at 60° C. for 2 hours. Subsequently, the mixture was allowed to polymerize under heating at 65° C. for three hours while holding the vessel horizontally and rotating it at a speed of rotation of 3,000 rpm, which was followed by annealing at 90° C. for 24 hours to thereby obtain hollow cylinder made of the copolymer of IBXMA and 6FM.

(Production of Core Region)

Next, a mixed solution of a monomer mixture of IBXMA and 6FM, both of them were reduced water content by 1000 ppm and the IBXMA to 6FM weight ratio was 1/1, and 10 wt % (with respect to the monomer mixture weight) of dibutyl phthalate as a refractive index adjuster was prepared. The mixed solution was directly poured into the hollow region of the obtained hollow cylinder while being filtered through a membrane filter, based on tetrafluoroethylene, having a pore size of 0.2 μm. 0.016 wt % (with respect to the monomer mixture weight) of di-t-butyl peroxide as a polymerization initiator and 0.27 wt % (with respect to the monomer mixture weight) of n-laurylmercaptan as a chain transfer agent were added to the mixed solution. A cylinder thus filled with the mixed solution was housed in a glass tube having a diameter larger by 9% than the outer diameter of the cylinder, and was then allowed to stand vertically in a pressure polymerization reactor. The inner atmosphere of the pressure polymerization reactor was then purged with nitrogen, pressurized up to 0.1 MPa, and the heat polymerization was allowed to proceed at 90° C. for 48 hours. Subsequently, pressurized up to 0.4 MPa, the heat polymerization and the heat treatment were carried out at 120° C. for 24 hours with keeping the pressured atmosphere to thereby obtain the preform. It was found that the obtained preform had a weight-average molecular weight of 106,000 and a molecular-weight distribution of 2.1.

The obtained preform observed when the polymerization completed was found to have no air bubbles contained therein which possibly introduced by mass shrinkage. The preform was drawn by thermal drawing at 230° C. so as to produce a plastic optical fiber having a diameter of approx. 700 to 800 μm. The preform was not found to include air bubbles during the drawing, which contributed to successfully obtain the fiber of 300 m long in a stable manner.

Measurements revealed that the obtained fiber had a light transmission loss of as small as 160 dB/km at 650 nm wave length, and 1250 dB/km at 850 nm wave length. After allowed to stand overnight at 75° C. under RH 90%, the light transmission loss of the fiber was measured, and it was found that the increase in light transmission loss of the fiber was not larger than 50 dB/km at 850 nm.

Next, the outer surface of the obtained fiber was coated with polyethylene to form a primary coating layer having 0.35 mm thickness, and subsequently the outer surface of the primary coating layer was coated with polyethylene to form a secondary coating layer having 0.45 mm thickness. Thus, the cable consisting of the fiber, the primary coating layer and secondary coating layer was obtained. A bending test was performed for the obtained cable according to the method disclosed in JPA No. 1995-244220, thereby finding a value (dB) of transmission light loss due to bending of the cable. Specifically, the value of light transmission loss of the cable was measured while the cable was wrapped by 90° around a mandrel having a 60 mm diameter, and the increase of light transmission loss due to bending was found. A maximum value of the increase was defined as a value of light transmission loss due to bending. The measured value was shown in Table bellow.

### Examples 12 to 18 and Comparative Examples 11 and 12

Various fibers and cables of Examples 12 to 18 and Comparative Examples 11 and 12 were produced in the same manner as Example 11, except that the species or the amounts of monomers or refractive index adjusters for the clad region or the core region were respectively changed as shown in Table 2 bellow. The obtained fibers and cables were evaluated in the same manner as Example 11, and the results are shown in Table 2 bellow. It was noted now that only amounts of a polymerization initiator and a chain transfer agent were changed and species thereof were not changed, such that the molecular weights of the obtained polymers were about 100,000.

TABLE 2

| | | | | | | Increase in | |
|---|---|---|---|---|---|---|---|
| | | | | | | LTL*2 caused | Increase in |
| | Clad region | Core region | | LTL*2 | | by humidity | LTL*2 caused |
| | Monomers | Monomers | | (dB/km) | | and heat | by bending |
| | (weight ratio) | (weight ratio) | Dopant*1 | 650 nm | 850 nm | (850 nm) | (dB) |
| Example 11 | IBXMA/6FM | IBXMA/6FM | DBP | 160 | 1250 | not greater | 0.09 |
| | (1/1) | (1/1) | | | | than 50 | |
| Example 12 | IBXMA/6FM | IBXMA/6FM | DBP | 160 | 1500 | not greater | 0.09 |
| | (1/1.5) | (1/1.5) | | | | than 50 | |
| Example 13 | IBXMA/3FM(D)/3FM | IBXMA/3FM(D)/3FM | DBP | 120 | 1100 | not greater | 0.09 |
| | (1/1/0.05) | (1/1/0.05) | | | | than 50 | |
| Example 14 | IBXMA/3FM(D)/3FM | IBXMA/3FM(D)/3FM | DBP | 105 | 840 | not greater | 0.08 |
| | (1/2/0.1) | (1/2/0.1) | | | | than 50 | |
| Example 15 | IBXMA(D)/3FM(D)/3FM | IBXMA(D)/3FM(D)/3FM | DBP | 85 | 520 | not greater | 0.07 |
| | (1/4/0.1) | (1/4/0.1) | | | | than 50 | |
| Example 16 | NBXMA(D)/3FM(D) | NBXMA(D)/3FM(D) | DBP | 140 | 790 | not greater | 0.08 |
| | (1/1) | (1/1) | | | | than 50 | |
| Example 17 | NBXMA(D)/3FM(D) | NBXMA(D)/3FM(D) | DBP | 120 | 560 | not greater | 0.07 |
| | (1/2) | (1/2) | | | | than 50 | |
| Example 18 | IBXMA(D)/3FM(D)/6FM(D) | IBXMA(D)/3FM(D)/6FM(D) | DBP | 105 | 330 | not greater | 0.08 |
| | (1/1/1) | (1/1/1) | | | | than 40 | |
| Comparative | MMA/6FM | MMA/6FM | DBP | 210 | 2700 | 800 | 0.07 |
| Example 11 | (10/1) | (10/1) | | | | | |
| Comparative | EMA/6FM | EMA/6FM | DBP | 210 | 2500 | 500 | 0.07 |
| Example 12 | (10/1) | (10/1) | | | | | |

*1 an agent for adjusting refractive index
*2 light transmission loss

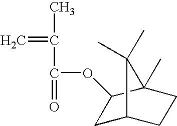

IBXMA

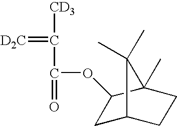

IBXMA(D)

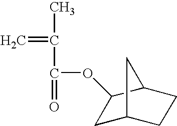

NBXMA

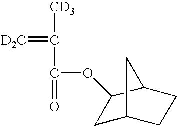

NBXMA(D)

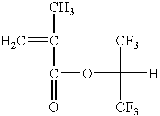

6FM

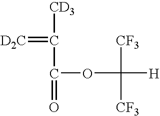

6FM(D)

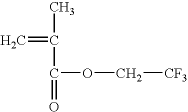

3FM

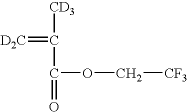

3FM(D)

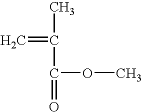

MMA

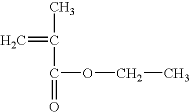

EMA

### Example 19

(Production of PVDF Pipe)

A melt extrusion of a modified poly-fluorine-vinylidene (modified-PVDF), “KF-#850” manufactured by Kureha Chemical Industry, Co., Ltd having a melting point of 178° C., was carried out at 120° C. into a hollow cylinder shape to form a PVDF pipe having an outside diameter of 19 mm, an inside diameter of 18 mm, a thickness of 0.5 mm and a length of 600 mm.

(Production of Outer Core Layer)

After the bottom portion was attached to one end of the obtained PVDF pipe, the PVDF pipe was placed in a cylindrical test cube having an inner diameter of 21 mm. A polymerizable composition containing a monomer mixture of isobornyl methacrylate (IBXMA) and methyl methacrylate (MMA), both of them were removed an polymerization inhibitor and reduced water content by 1000 ppm and the IBXMA to MMA weight ration was 2/8, 0.5 wt % (with respect to the monomer mixture weight) of dimethyl-2,2-azobisisobutylate as a polymerization initiator and 0.6 wt % (with respect to the monomer mixture weight) of n-laurylmercaptan as a chain transfer agent was directly poured into the hollow region of the obtained PVDF pipe while being filtered through a membrane filter, based on tetrafluoroethylene, having a pore size of 0.2 μm. The test tube supporting the PVDF pipe was ultra-sonic deaerated under a reduced pressure for five minutes, was stoppered with a silicon plug, was placed in the water bath at 60° C. and the polymerizable composition was shaken and pre-polymerized at 60° C. for 2 hours. Subsequently, the test tube was held horizontally and rotated at a speed of rotation of 3,000 rpm, such that the composition was adhered to the inner surface of the PVDF pipe by the centrifugal force, in a thermostat where the temperature was kept at 60° C. with hot air, to carry out polymerization of the polymerizable composition at 60° C. for an hour, subsequently heated up to 70° C., and to carry out the polymerization for four hours at 70° C. Finally, heated up to 90° C., the test tube was left for 24 hours at 90° C. Thus, a double layered tube having a clad portion formed of modified PVDF and an outer core layer formed of IBXMA-MMA copolymer.

(Production of Inner Core Region)

The double-layered tube was taken out of the test tube and preheated in a thermostat at 90° C. A polymerizable composition containing a monomer mixture of IBXMA and MMA, both of them were purified as same as above, 0.016 wt % (with respect to the monomer mixture weight) of di-t-butyl peroxide as a polymerization initiator, 0.27 wt % (with respect to the monomer mixture weight) of n-laurylmercaptan as a chain transfer agent and 10 wt % (with respect to the monomer mixture weight) of diphenylsulfide as a refractive index adjuster was filtered through a membrane filter, based on tetrafluoroethylene, having a pore size of 0.2 μm and poured into the hollow region of the double-layered tube preheated at 90° C. The double-layered tube was deaerated under a reduced pressure for five minutes, inserted to a glass tube, and placed in a pressurized polymerization vessel. After the vessel was sealed, the atmosphere in the vessel was replaced with nitrogen gas fully and pressurized up to 0.1 MPa. The vessel was heated up to 100° C. and the polymerization of the composition in the vessel was carried out at 100° C. for 48 hours. Subsequently the vessel was pressurized up to 0.8 MPa and heated up to 120° C., and the polymerization and the heat treatment were carried out at 120° C. for 24 hours, to form an inner core region formed of a IBXMA-MMA copolymer. After termination of the polymerization, keeping a pressure of 0.1 MPa, the vessel was cooled down to 80° C. which is lower than Tg of the inner core region at a rate of 0.01° C./min. Thus, a preform was obtained.

(Drawing)

The obtained preform observed when the polymerization completed was found to have no air bubbles contained therein which possibly introduced by mass shrinkage. The preform was drawn by thermal drawing at 230° C. so as to produce a plastic optical fiber having a diameter of approx. 500 μm. The preform was not found to include air bubbles during the drawing, which contributed to successfully obtain the fiber of 300 m long in a stable manner.

(Forming a Primary Coating Layer)

Next, the outer surface of the obtained fiber was coated with low-density-polyethylene (LDPE), “J-REX07A” manufactured by Japan POLYOLEFINS co., Ltd. having a flow-starting temperature of 106° C. with coating equipment having a crosshead die. Thus, the coated fiber having a mean outside diameter of 1.2 mm and consisting of the fiber and a primary coating layer formed of LDPE which was stuck to the fiber surface and of which thickness was 0.35 mm, was obtained.

(Forming a Secondary Coating Layer)

[symbol]

Preparation of Nonflammable Coating Composition

[symbol]

A twin-screw extruder manufactured by Berstorffo having a screw diameter of 40 mm and a screw L/D of 40, comprising four combination sets of kneading discs arranged FD/FD/ND/ND/RD in the direction of extrusion, where RD is a reverse-feed kneading disc, ND is a neutral-kneading disc and FD is a forward-feed disc and lengths thereof are 1D, placed between screw units was used. Polyethylene (PE) having a flow starting temperature of 103° C., a melt flow rate of 80 g/10 min measured according to JIS K 6922-2 and a density of 0.916 g/cm³; and magnesium hydrate having a mean grain diameter of 2 μm and a 99% grain diameter of 5 μm were fed to the above twin-screw extruder at a rate of 8 kg/hr respectively through different volumetric feeders, so that the mixed composition containing 50 wt % of magnesium hydrate was obtained. The polymer strand was extruded from a nozzle (φ5 mm×10) of the extruder under at an extrusion outlet temperature of 70° C. The screw rotation speed was 100 rpm and the bent-pressure was 0.85 atm. The strand was cut into pellets formed of a nonflammable composition containing magnesium hydrate, having a diameter of 2 mm and a length of 2 to 3 mm.

[symbol]

Coating of Nonflammable Coating Composition

[symbol]

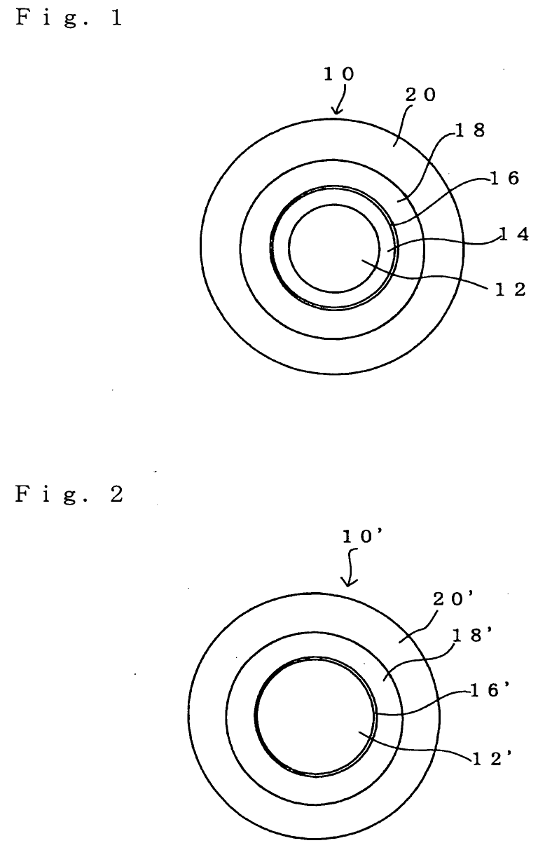

A coating extruder (a dice diameter of 6.7 mm; a nipple diameter of 4.5 mm) of which a crosshead die was replaced, was used. The outer surface of the fiber coated with the primary coating layer was coated with the obtained nonflammable composition by carrying the coated fiber on the coating line of the coating extruder at rate 20 m/min. Thus, a cable having an outside diameter of 2 mm and a secondary layer formed of the nonflammable composition having a thickness of 0.4 mm, was obtained. FIG. 1 was a schematic sectional view of the obtained cable. The obtained optical fiber cable 10 consisted of an inner core region 12, an outer core region 14, a clad portion 16, a primary coating layer 18 and secondary coating layer 20, respectively having a thickness of 0.3 mm, 0.085 mm, 0.015 mm, 0.35 mm and 0.4 mm, from the center toward the outer surface.

Measurements revealed that the obtained fiber had a light transmission loss of as small as 170 dB/km at 650 nm wave length, and 2700 dB/km at 850 nm wave length. And the transmission band of the obtained fiber of 100 m length was measured to be 1 GHz. The 13 m length fiber was cut out of the obtained fiber, and placed in a compact environmental testing equipment “SH-240” such that the central 10 m part of the fiber was inside of the equipment and 1 m part and 2 m part from both ends of it were respectively outside of the equipment. The 1 m part fiber outside of the equipment was connected to a white light source, “AQ4303B” manufactured by Ando Electronic Co., Ltd., into which a band-pass filter manufactured by MELLES GLIOT Co., Ltd., through a FC connector, “MA9013A” manufactured by Anritsu Co., Ltd.; and the 2 m part fiber outside of the equipment was connected to an optical power meter, “ML910B” manufactured by Anritsu Co., Ltd., through a same FC connector as the above. After the 10 m part fiber was placed in a thermostat of 70° C.-95 RH % for 500 hours, decay in light strength was measured to be 1 dB. Next, a bending test was performed for the obtained cable according to the method disclosed in JPA No. 1995-244220, thereby finding a value (dB) of transmission light loss caused by bending of the cable. Specifically, the value of light transmission loss of the cable was measured while the cable was wrapped by 90° around a mandrel having a 60 mm diameter, and the increase of light transmission loss due to bending was found. A maximum value of the increase was 0.07 dB.

### Example 20

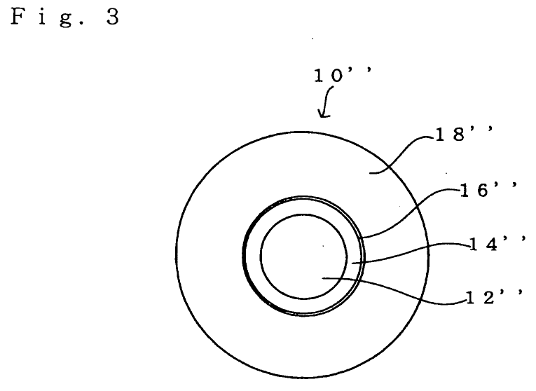

An optical fiber and cable were prepared with same materials and in the same manner as the Example 19, except that a thickness of the outer core layer was 2 mm in the preform and the outer core layer in the fiber had no longer any thickness, as shown in FIG. 2. FIG. 2 was a schematic sectional view of the obtained cable. The obtained cable 10′ consisted of an inner core region 12′, a clad region 16′, a primary coating layer 18′ and a secondary coating layer 20′, respectively having a thickness of 0.47 mm, 0.015 mm, 0.35 mm and 0.4 mm, from the center toward the outer surface. The obtained cable and fiber were evaluated in the same manner as the Example 19 and the obtained results are shown in Table 3.

### Example 21

An optical fiber and cable were prepared with same materials and in the same manner as the Example 19, except that thicknesses of the regions and layers were changed and the secondary layer was not prepared. FIG. 3 was a schematic sectional view of the obtained cable. The obtained cable 10″ consisted of an inner core region 12″, an outer core layer 14″, a clad region 16″ and a primary coating layer 18″, respectively having a thickness of 0.50 mm, 0.085 mm, 0.015 mm and 0.725 mm, from the center toward the outer surface. The obtained cable and fiber were evaluated in the same manner as the Example 19 and the obtained results are shown in Table 3.

### Examples 21 and 23

An optical fiber and cable were prepared with same materials in the same manner as the Example 19, except that MMA was replaced with all deuterated MMA (MMA-d8) and diphenylsulfide was replaced with deuterated bromobenzene (BB-d5).

An optical fiber and cable were prepared with same materials in the same manner as the Example 20, except that MMA was replaced with all deuterated MMA (MMA-d8) and diphenylsulfide was replaced with deuterated bromobenzene (BB-d5).

The obtained fibers and cables were respectively evaluated in the same manner as Example 19 and the obtained results are shown Table 3.

### Examples 24 and 25

An optical fiber and cable were prepared with same materials in the same manner as the Example 19, except that MMA was replaced with all deuterated MMA (MMA-d8) and diphenylsulfide was replaced with DPS derivative (D3).

An optical fiber and cable were prepared with same materials in the same manner as the Example 20, except that MMA was replaced with all deuterated MMA (MMA-d8) and diphenylsulfide was replaced with DPS derivative (D3).

The obtained fibers and cables were respectively evaluated in the same manner as Example 19 and the obtained results are shown Table 3.

### Examples 26 and 27

An optical fiber and cable were prepared with same materials in the same manner as the Example 19, except that MMA was replaced with all deuterated MMA (MMA-d8), IBXMA was replaced with deuterated IBXMA (IBXMA(D) and diphenylsulfide was replaced with DPS derivative (D3).

An optical fiber and cable were prepared with same materials in the same manner as the Example 20, except that MMA was replaced with all deuterated MMA (MMA-d8), IBXMA was replaced with deuterated IBXMA (IBXMA(D) and diphenylsulfide was replaced with DPS derivative (D3).

The obtained fibers and cables were respectively evaluated in the same manner as Example 19 and the obtained results are shown Table 3.

### Comparative Example 13

An optical fiber and cable were prepared with same materials in the same manner as the Example 19, except that the monomer mixture was replaced with MMA.

The obtained fiber and cable were respectively evaluated in the same manner as Example 19 and the obtained results are shown Table 3. It is noted now that the decay in light strength was measured after the 10 m part fiber was placed in a thermostat of 70° C.-95 RH % for 100 hours.

### Examples 28 and 29

An optical fiber and cable were prepared with same materials in the same manner as the Example 19, except that the monomer mixture was replaced with a monomer mixture of all deuterated MMA (MMA-d8) and deuterated IBXMA (IBXMA(D)) of which the MMA-d8 to IBXMA(D) weight ratio was 7/3, and diphenylsulfide was replaced with DPS derivative (D3).

An optical fiber and cable were prepared with same materials in the same manner as the Example 20, except that the monomer mixture was replaced with a monomer mixture of all deuterated MMA (MMA-d8) and deuterated IBXMA (IBXMA(D)) of which the MMA-d8 to IBXMA(D) weight ratio was 7/3, and diphenylsulfide was replaced with DPS derivative (D3).

The obtained fibers and cables were respectively evaluated in the same manner as Example 19 and the obtained results are shown Table 3.

### Examples 30 and 31

An optical fiber and cable were prepared with same materials in the same manner as the Example 19, except that the monomer mixture was replaced with a monomer mixture of MMA and norbornyl methacrylate (NBXMA) of which the MMA to NBXMA weight ratio was 7/3, and the one step polymerization was carried out at 100° C. for 96 hours to form an inner core region.

An optical fiber and cable were prepared with same materials in the same manner as the Example 20, except that the monomer mixture was replaced with a monomer mixture of MMA and norbornyl methacrylate (NBXMA) of which the MMA to NBXMA weight ratio was 7/3, and the one step polymerization was carried out at 100° C. for 96 hours to form an inner core region.

The obtained fibers and cables were respectively evaluated in the same manner as Example 19 and the obtained results are shown Table 3.

### Examples 32 and 33

An optical fiber and cable were prepared with same materials in the same manner as the Example 19, except that the monomer mixture was replaced with a monomer mixture of MMA and norbornyl methacrylate (NBXMA) of which the MMA to NBXMA weight ratio was 7/3, and the cooling step after polymerization was carried out at 4° C./min.

An optical fiber and cable were prepared with same materials in the same manner as the Example 20, except that the monomer mixture was replaced with a monomer mixture of MMA and norbornyl methacrylate (NBXMA) of which the MMA to NBXMA weight ratio was 7/3, and the cooling step after polymerization was carried out at 4° C./min.

The obtained fibers and cables were respectively evaluated in the same manner as Example 19 and the obtained results are shown Table 3.

TABLE 3

| | | | | Decrease | |
|---|---|---|---|---|---|
| | | | Decay in | in LTL*1 | |
| | | | light | caused by | |
| | LTL *1 (dB/km) | | strength | bending | LTB *2 |
| | 650 nm | 850 nm | (dB) | (dB) | GHz · 100 m |
| Example 19 | 170 | 2700 | 1 | 0.07 | 1 |
| Example 20 | 173 | 2700 | 1 | 0.07 | 1 |
| Example 21 | 165 | 2650 | 1 | 0.05 | 1 |
| Example 22 | 100 | 560 | 1 | 0.07 | 1 |
| Example 23 | 95 | 530 | 1 | 0.07 | 1 |
| Example 24 | 105 | 580 | 1 | 0.05 | 1 |
| Example 25 | 103 | 550 | 1 | 0.05 | 1 |
| Example 26 | 85 | 380 | 1 | 0.06 | 1 |
| Example 27 | 85 | 370 | 1 | 0.06 | 1 |
| Comparative | 170 | 3000 | 30 | 0.07 | 1 |
| Example 13 | | | | | |
| Example 28 | 80 | 350 | 1 | 0.05 | 1 |
| Example 29 | 90 | 480 | 1 | 0.07 | 1 |
| Example 30 | 160 | 2430 | 1 | 0.07 | 1 |
| Example 31 | 165 | 2480 | 1 | 0.05 | 1 |
| Example 32 | 173 | 2550 | 1 | 0.05 | 1 |
| Example 33 | 173 | 2550 | 1 | 0.05 | 1 |

*1 light transmission loss
*2 light transmission band

### INDUSTRIAL AVAILABILITY

The present invention contributes to preparing an optical member having an excellent light transmission property, especially of which light transmission loss is originally little and of which an increase of a light transmission loss due to humidity or heat is little, in good productivity. The present invention also contributes to preparing an optical member, which has an excellent light transmission property and is improved in its various properties such as thermostability and nonhydroscopic in a balanced manner, in good productivity.

Having described our invention as related to the present embodiments, it is our intention that the invention not be limited by any of the details of the description, unless otherwise specified, but rather be construed broadly within its spirit and scope as set out in the accompanying claims.

1-21. (canceled)

22. A polymerizable composition comprising a polymerizable monomer composition comprising a compound (A) denoted by Formula (1) shown below and a compound (B) denoted by Formula (2) shown below: 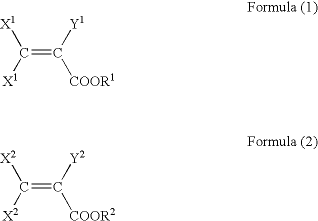
where X¹ and X² respectively denote hydrogen (H) or deuterium (D) and two X¹'s and two X²s may be identical or different each other; Y¹ and Y² respectively denote H, D, CH₃, CD₃ or fluorine (F); R¹ is a branched C3-8 alkyl group; R² is a C1-7 fluoroalkyl group substituted with 1 to 15 fluorine atoms; and the compound (A) to the compound (B) mole ratio is not less than 1/100 and less than 4/1; and
a polymerization initiator capable of initiating polymerization of the polymerizable monomer composition.

23. The composition of claim 22 further comprising a chain transfer agent.

24. The composition of claim 22 further comprising a refractive index adjuster having a different refractive index from that of the polymerizable monomer composition.

25. A process for preparing an optical member comprising polymerizing a composition of claim 22 to form a region having a distributed refractive index.

26. The process of claim 25 wherein the polymerization is carried out according to an interfacial-gel polymerization.

27. An optical member prepared by a process of claim 25.

28. An optical member comprising a core region having a distributed refractive index, which is prepared by polymerization of a composition of claim 22 and a clad region cladding the core region.

29. An optical member essentially formed of a copolymer denoted by Formula (X): 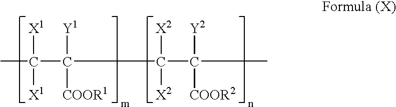
where X¹ and X² respectively denote hydrogen (H) or deuterium (D) and two X¹'s and two X²s may be identical or different each other; Y¹ and Y² respectively denote H, D, CH₃, CD₃ or fluorine (F); R¹ is a branched C3-8 alkyl group; R² is a C1-7 fluoroalkyl group substituted with 1 to 15 fluorine atoms; m and n respectively denote a mole ratio of a repeating unit provided that m/n is not less than 1/100 and less than 4/1.

30. The optical member of claim 29 wherein the copolymer has a weight-average molecular weight within a range from 10,000 to 1,000,000.

31. The optical member of claim 29 comprising a region comprising a matrix formed of the copolymer and a compound contained in the matrix wherein the region has a concentration distribution of the compound, thereby having the distribution in the refractive index.

32. An optical fiber prepared by drawing an optical member of claim 27.

33. An optical fiber prepared by drawing an optical member of claim 28.

34. An optical fiber prepared by drawing an optical member of claim 29.

35. A process for preparing an optical member comprising polymerizing a polymerizable composition comprising a polymerizable monomer composition comprising a compound denoted by Formula (3): 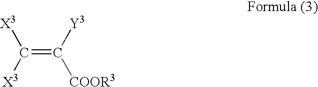
where X³ denotes hydrogen (H) or deuterium (D) and two X³s may be identical or different each other; Y³ is H, D, CH₃ or CD₃; and R³ is a C7-20 alicyclic hydrocarbon group; a polymerization initiator for initiating the polymerizable monomer composition; and a compound having a different refractive index from that of the polymerizable monomer composition, in a hollow vessel, to form a polymer toward a center from an inner surface of the vessel.

36. The process of claim 35, wherein the polymerizable monomer composition further comprises a compound denoted by Formula (4): 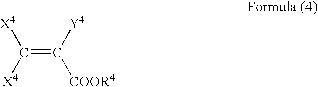
where X⁴ is H or D and two X⁴s may be identical or different each other; Y⁴ is H, D, CH₃ or CD₃; and R⁴ is a C1-7 fluoroalkyl group substituted with 1 to 15 fluorine atoms.

37. The process of claim 33, wherein the polymerization of the polymerizable composition is carried out according to an interfacial-gel polymerization.

38. A process for preparing an optical member comprising polymerizing a polymerizable composition comprising a polymerizable monomer composition comprising a compound denoted by Formula (3): 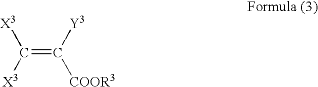
where X³ denotes hydrogen (H) or deuterium (D) and two X³s may be identical or different each other; Y³ is H, D, CH₃ or CD₃; and R³ is a C7-20 alicyclic hydrocarbon group; a polymerization initiator for initiating the polymerizable monomer composition; and a compound having a different refractive index from that of the polymerizable monomer composition, to form a region having a distributed refractive index.

39. The process of claim 38, wherein the polymerizable monomer composition further comprises a compound denoted by Formula (4): 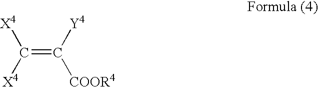
where X⁴ is H or D and two X⁴s may be identical or different each other; Y⁴ is H, D, CH₃ or CD₃; and R⁴ is a C1-7 fluoroalkyl group substituted with 1 to 15 fluorine atoms.

40. An optical member prepared by a process of claim 35.

41. An optical member prepared by a process of claim 38.

42. An optical member comprising a region having a distributed refractive index which is essentially formed of a polymer having a molecular weight from 10,000 to 1,000,000 and comprising a repeating unit denoted by Formula (X-1): 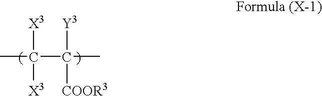
where X³ denotes hydrogen (H) or deuterium (D) and two X³s may be identical or different each other; Y³ is H, D, CH₃ or CD₃; and R³ is a C7-20 alicyclic hydrocarbon group.

43. The optical member of claim 42 wherein the polymer further comprises a repeating unit denoted by Formula (X-2): 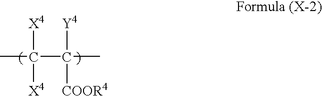
where X⁴ is H or D and two X⁴s may be identical or different each other; Y⁴ is H, D, CH₃ or CD₃; and R⁴ is a C1-7 fluoroalkyl group substituted with 1 to 15 fluorine atoms.

44. The optical member of claim 42 comprising a region comprising a matrix formed of the polymer and a compound contained in the matrix wherein the region has a concentration distribution of the compound, thereby having the distribution in the refractive index.

45. An optical fiber prepared by drawing an optical member of 40.

46. An optical fiber prepared by drawing an optical member of 41.

47. An optical fiber prepared by drawing an optical member of 42.
